(19) United States
(12) Patent Application Publication
(10) Pub. No.: US 2018/0020615 A1
(43) Pub. Date: Jan. 25, 2018

(54) EASY LOAD TRIMMER HEAD SPOOL WITH NON-RADIAL GUIDE CHANNEL

(71) Applicant: George E. Alliss, Fairmont, NC (US)

(72) Inventor: George E. Alliss, Fairmont, NC (US)

(21) Appl. No.: 15/705,496

(22) Filed: Sep. 15, 2017

Related U.S. Application Data
(63) Continuation-in-part of application No. 15/376,474, filed on Dec. 12, 2016.
Application No. 15/376,474 is a continuation-in-part of application No. 14/548,392, filed on Nov. 20, 2014, now Pat. No. 9,516,807.
(60) Provisional application No. 61/907,883, filed on Nov. 22, 2013.
(60) Provisional application No. 62/397,313, filed on Sep. 20, 2016.

(51) Int. Cl. A01D 34/416

(52) U.S. Cl. CPC A01D 34/4163

(57) ABSTRACT

A trimmer head spool for a vegetation trimmer machine. The spool includes a hub that defines a bore and has at least one flange or a plurality of spokes extending radially outwardly therefrom. A trimmer line conduit is defined in the spool and includes a first funnel defined in a first region of the flange or spokes and a second funnel defined in a second region of the flange or spokes. A non-radial guide channel is in fluid communication with the first and second funnels. The non-radial guide channel spans the hub's bore and does not extend through a central axis of the spool about which the spool is rotatable. The non-radial guide channel may be provided on a module that is selectively inserted into the bore and aligned with the first and second funnels. In other embodiments the entire trimmer line conduit is integrally formed in the spool.

### CROSS REFERENCE TO RELATED APPLICATIONS

This application is a Continuation-in-Part of U.S. application Ser. No. 15/376,474 filed Dec. 12, 2016, which is a Continuation-in-Part of U.S. patent application Ser. No. 14/548,392 filed Nov. 20, 2014, now Pat. No. 9,516,807, which claims the benefit of U.S. Provisional Application No. 61/907,883 filed Nov. 22, 2013.

The present application also claims the benefit of U.S. Provisional Application No. 62/397,313 filed Sep. 20, 2016.

The disclosures of each of the above U.S. applications are incorporated herein by reference.

### BACKGROUND

### Technical Field

This disclosure relates generally to line type vegetation trimmer heads for rotary trimmers and more particularly to “Easy Loading” trimmer heads for rotary trimmers that use monofilament trimmer line as a means for cutting vegetation. Specifically, this disclosure may be directed to a trimmer head spool that may include a non-radial guide channel through which trimmer line may be routed across the spool's hub; where the non-radial guide channel, in a first embodiment, may be defined at least partially in a replaceable module that may be selectively engaged with the spool or, in a second embodiment, where the non-radial guide channel may be integrally formed with the spool.

### Background Information

There are a number of different classes of rotary trimmer heads, defined generally by the manner in which the trimmer line is fed, spooled or replaced in the trimmer head and by how the trimmer line is discharged, indexed or lengthened during use of the trimmer head.

So called “fixed line” trimmer heads utilize pieces of line that are of a fixed length. Once the line wears down through use to a length that may be too short to cut vegetation, the consumer has to stop the motor and remove the short remnant of line. A replacement piece of line of a fixed length has to then be engaged with the trimmer head. The replacement piece of line may be one from a purchased package of pre-cut fixed line sections or the consumer can cut a pre-determined length of line from a roll. The replacement piece of line may be engaged with the trimmer head by inserting the same into a clamping mechanism or any other type of engagement mechanism provided on the trimmer head. The majority of aftermarket trimmer heads for rotary trimmers tend to be fixed line trimmer heads because these trimmer heads are designed to be adapted to functioning in many brands of rotary trimmer, regardless of the method of operation of the trimmer head.

The second class of rotary trimmer head may be known as an “auto dispensing” trimmer head. These devices are self-indexing and automatically dispense a length of line from the spool. The only force that determines how the trimmer line may be dispensed may be the air-drag on the line. For this class of trimmer heads the housing may be connected to the rotating driveshaft of the trimmer machine. The trimmer head may include a mechanism to lock and unlock the relative rotation of the spool therein based upon centrifugal forces. The change in rotation changes the line length. As the line wears away through use, there may be less air drag on the line and the rotational speed of the trimmer head increases. The increased rotational speed unlocks the spool thus allowing line to be released therefrom. As the length of the line increases the air drag on the longer piece of line increases and the rotational speed of the head slows down once again. A locking mechanism provided on the trimmer head locks the spool against rotation once more and the dispensing of line from the spool may be halted. This process may be repeated over and over as the trimmer may be used. The dispensing of the line may be therefore controlled entirely by the trimmer itself and there may be no action required on the part of the user to dispense line from the spool.

Yet other trimmers are “semi-auto dispensing” trimmers. These are commonly known as “bump and feed” trimmers and they include an internal storage spool. This type of trimmer head may be most popular and almost all manufacturers of weed trimmer machines equip their new machines with this type of trimmer head. A bump-activated trimmer head may be designed with a bump knob located on the second end of the trimmer head and extending outwardly from the trimmer head housing. When needed, the user manually taps (or bumps) the knob on the ground for the purpose of dispensing more line. The bumping action creates a vertical upward force which lifts the spool upward within the housing. For a brief moment the spool may be no longer locked to the housing and may be therefore able to rotate independently of the housing. The difference in the speed of rotation of the housing relative to the spool causes a length of line to be released from the head. The spool then drops downwardly within the housing and further dispensing of trimmer line ceases.

Initially, manual, semi-automatic and automatic dispensing spools did not include passageways and as a result the spool had to be removed from the trimmer head housing and the user had to very carefully wind a length of trimmer line onto the spool. Once a length of line was wrapped around the spool, the user had to very carefully place the spool back into the trimmer head housing without allowing the line to unwind from the spool. This was an extremely problematic and difficult task.

One type of bump-feed type trimmer head now available may be known as an easy load trimmer head. These trimmer heads generally have two features not found in other types of bump-feed trimmer heads. Easy load trimmer heads typically include a one-way ratcheting system for winding line onto the spool and for dispensing small increments of trimmer line through one of more eyelets provided in the trimmer head housing. Easy load type spools may also have one or more passageways defined therein and through which the trimmer line may be fed to or from the spool. The passageway(s) may be used for the purpose of preloading a length of trimmer line onto the spool without having to remove the spool from the trimmer head housing. The passageways in some spools may also be used to anchor the trimmer line and to aid in evenly winding the line into the spool's storage compartment(s).

The method used to position and preload line onto the spool may be one of the most important factors for determining the ease of loading line onto the spool prior to rotating and winding the line onto the spool. The term “loading” or “preloading” may be used herein to describe the process of initially engaging trimmer line with the spool. The term “winding” may be used herein to describe the process of rotating the spool so that a length of trimmer line becomes wrapped around an exterior wall of the spool's cylindrical hub and may be thereby retained in a storage compartment of the spool. Winding occurs after the trimmer line has already been “loaded” or “preloaded” onto the spool. The term “anchored” or “anchoring” as used herein may describe a possible intermediate step between “loading” and “winding”. Anchoring the trimmer line may involve a method or mechanism for capturing a section of trimmer line in some manner after loading has occurred and so that once winding begins, the trimmer line does not become disengaged from the spool or simply rotate with the spool but not progressively accumulate around the hub of the spool. There are a wide variety of different ways and configurations currently known to accomplish loading of trimmer line onto spools. At the basis of each of these methods may be some type of anchoring of the trimmer line to make it possible to wind the line onto the exterior surface of the spool's hub.

One method of loading and anchoring trimmer line on a spool involves providing a straight, radial passageway on the spool and through which the trimmer line may be threaded prior to beginning the winding process. An easy load trimmer head that uses this feature may be disclosed in Pfaltzgraff (U.S. Pat. Nos. 6,952,877; 7,607,232 and 7,979,991). These patents disclose a spool having first, second and intermediate flanges that extend radially outwardly from an exterior surface of the spool's cylindrical hub. A straight, tubular passageway may be provided through the spool's hub and this passageway may be coplanar with the intermediate flange. The passageway may be of substantially constant cross-section along its length. The passageway passes through a central axis of the hub; where the central axis may be the axis about which the spool rotates in response to the rotation of the trimmer machine's driveshaft. A single length of trimmer line may be inserted into a first opening to the passageway, may be passed through the length of the passageway (thereby passing through the central axis) and may be pulled out of the second opening to the passageway. In a preloading stage, the length of trimmer line may be pulled through the passageway until the sections of the line extending into the first opening and out of the second opening are substantially of equal length. The spool may be then rotated about the central axis to wind the trimmer line into the spool's storage compartments. Once the spool is rotated through at least one to two full revolutions, the trimmer line is anchored to the spool.

The problem with using a straight, radial passageway may be that this limits the type of trimmer machine with which such a spool may be engaged. The reason for this limitation may be based in the fact that there are two basic types of trimmer machine driveshaft. The first type of driveshaft may be “short” and the second type of driveshaft may be “long”. Vegetation trimmer machines are handheld devices that are powered by an electric motor, a combustion engine or any other type of motor. A steering handle may be used for holding, guiding and directing the trimmer machine during use. The handle may be engaged with a shaft that may be hollow and, within the hollow portion, the shaft may contain a mechanical connection (referred to herein as a driveshaft or driveshaft arbor) that couples the motor to the trimmer head. The majority of manufactures use a threaded fastener (e.g. a male and/or female nut and bolt) to secure the housing of the trimmer head to a threaded driveshaft or driveshaft arbor. There are driveshaft arbors for attaching a trimmer head that are relatively “short” in length and there are driveshaft arbors that are “longer”. The “short” driveshafts or driveshaft arbors extend through a center top opening of the housing and are secured to the housing. The “long” driveshafts or driveshaft arbors, on the other hand, extend through the top center opening of the housing of the trimmer head but additionally extend through the center of the spool and beyond. The term “long driveshaft” as used herein should be understood to refer to a long driveshaft or long driveshaft arbor that extends through a central opening located along a central axis of the spool and beyond. The term “short driveshaft” as used herein should be understood to refer to a short driveshaft or short driveshaft arbor that does not go through a central opening or central axis of the spool.

A trimmer head spool having a straight, radial passageway therethrough cannot be used on a trimmer machine that has a long driveshaft as this type of driveshaft passes through the center of the spool and would therefore have to pass through the center of the radial passageway. As a result, trimmer head spools that have a straight radial passageway can only be used on trimmer machines that have short driveshafts. Utilizing a spool with a straight radial passageway on a trimmer machine that has a long driveshaft designed to pass through the center of the spool may be therefore not possible.

Griffini et al (5,765,287) also discloses a spool that can only be used with short driveshafts. The reference discloses a spool having cylindrical hub with upper and lower flanges extending radially outwardly therefrom. The hub has at least two apertures aligned along an axis intersecting the axis of the spool. As a result, this spool cannot be engaged with long driveshaft trimmer machines as the long driveshaft pass through the axis of the spool. In Griffini's device the at least two apertures are disposed along an inclined axis with respect to a spool axis of rotation. The apertures may be alignable with eyelets provided in a housing for the spool. An end of a length of trimmer may be inserted into one eyelet, through one of the apertures, through the other aperture and subsequently out of the other eyelet. A separator may be provided extending radially outwardly from the hub and a first one of the apertures may be located above the separator and the other of the apertures may be located below the separator. A metal tube may be permanently inserted through the opposing apertures and may be secured to the hub. The metal tube may be a straight, radial tube that passes through the axis of rotation of the spool. The trimmer line may be fed through this metal tube and thereby be anchored to the spool. The tube may extend outwardly for a distance from the apertures and beyond the exterior surface of the hub.

Several other methods for anchoring trimmer line to spools have been proposed in the prior art to enable trimmer heads to be engaged with trimmer machines having long driveshafts. Proulx (U.S. Pat. No. 7,275,324), for example, discloses a spool that has a cylindrical hub with a top flange and a bottom flange extending radially outwardly therefrom. The top flange defines two opposed line receptors therein. Each line receptor originates in an outer edge of the flange and extends inwardly toward the hub. Each line receptor may be polygonal in cross-section along its length from the outer edge to the hub. The surfaces of the flange that define the line receptors taper inwardly. As a consequence, the line receptors have a region proximate the outer edge that may be wider than a region that may be proximate the hub. The line receptors taper to such a degree that, proximate the hub, the line receptor may be of smaller diameter than the diameter of a trimmer line to be engaged with the spool. Trimmer line may be loaded onto the spool by engaging two separate pieces of trimmer line into the two line receptors. This may be accomplished by inserting an end of each section of trimmer line into one of the line receptors. The trimmer line end may be pushed inwardly into the tapering line receptor to the point that that the end becomes frictionally trapped, thus anchoring the trimmer line section to the spool. Proulx further discloses that a slot extends outwardly from part of the line receptor. This slot originates proximate the outer edge and angles inwardly toward the hub. The slot may be bounded and defined by opposed guide wall surfaces that are substantially parallel to each other. Trimmer line extending outwardly from the trapped end may be captured by the slot and may be directed thereby toward the hub. This arrangement facilitates easier winding of the trimmer line onto the spool's hub and into the spool's single storage chamber. The Proulx spool has an central bore that extends from an upper end of the spool to a lower end thereof. Consequently, the spool may be used with trimmer machines that have a long driveshaft.

Everts et al (U.S. Pat. Nos. 5,806,192 and 6,148,523) discloses a spool having a first flange, a second flange and an intermediate flange that all extend radially outwardly from a cylindrical hub. The hub defines a central bore that extends from a top end of the spool to a bottom end thereof. Consequently, the spool may be used on trimmer machines that have a long driveshaft. In order to load and anchor trimmer line to the spool, Everts discloses that a pair of opposed passageways are formed in the intermediate flange. Each passageway may be formed entirely within the flange and hub and extends from an opening defined in the outer edge of the intermediate flange to an opening defined in the interior surface of the hub. Each passageway may be non-radial, has a polygonal opening that may be generally rectangular in shape, and may be of a greater cross-sectional size than the diameter of the trimmer line that may be to be wound onto the spool. The opening at the outer edge may be described as being a funnel. Each outer edge opening may be aligned with one of the eyelets in the trimmer head housing. An end of a piece of trimmer line may be fed into each one of the eyelets, into the associated passageway and may be pushed through the passageway until the end emerges through the opening in the hub's interior surface. The user pulls the end of each piece of trimmer line downwardly past the bottom end of the spool and then inserts the end upwardly into a vertically oriented hole defined in the second flange. The insertion of the ends of the trimmer line pieces into the vertically oriented holes anchors the trimmer line to the spool. The user may then manually rotate the spool to wind trimmer line into the upper and storage chambers defined on the spool. While Everts discloses a non-radial passageway through which trimmer line may be threaded, this non-radial passageway may be located entirely within the intermediate flange and terminates at the opening in the interior surface of the hub.

Stark et al (6,263,580) discloses a spool having first, second and intermediate flanges that extend radially outwardly from a cylindrical hub. The hub defines a bore through which a long driveshaft may be received. The intermediate flange may be formed with a plurality of undulations therein. A pair of diametrically opposed passageways may be defined in the spool. Each passageway may be generally L-shaped and may include a first region defined in the intermediate flange and a second region defined in the hub wall. The second region may be oriented at right angles to the first region and terminates in an opening in one end of the spool. Part of the first region of the passageway forms a funnel proximate an outer edge of the intermediate flange. The passageway may be of a greater cross-sectional size than the diameter of the trimmer line that may be ultimately inserted through the passageway. The funnel may be polygonal in construction and may be of a greatest height and width proximate the outer edge of the flange. A radially shorter wall section on each funnel forms a line guide from the funnel and towards one of the trimmer line storage compartments defined on the spool. The line guides are oriented opposite to each other so that one line guide directs trimmer line to a first storage compartment and the other line guide directs trimmer line to a second storage compartment. An end of a separate piece of trimmer line may be inserted through one of the eyelets provided in the housing surrounding the spool and subsequently into an aligned funnel of one of the passageways. The trimmer line end may be threaded through the horizontally oriented first region of the passageway and into the vertically oriented second region thereof to anchor the piece of trimmer line to the spool. Once anchored, the trimmer line extends outwardly through the funnel and passes through the line guide and into one or the other of the first storage compartment or the second storage compartment as may be wound onto the spool as the spool may be rotated.

It should be noted that several of the aforementioned trimmer head spools may only be engaged with a trimmer machine that has a short driveshaft. Other of the aforementioned trimmer head spools may only be engaged with a trimmer machine that has a long driveshaft.

### SUMMARY

The present disclosure relates to a more versatile spool that may be used in some trimmer machines that have a short drive shaft and in other instances may be used in trimmer machines that have a long drive shaft.

The spool disclosed herein may include a non-radial guide channel that extends across the hub of the spool but does not pass through the axis of rotation of the spool. Because the non-radial guide channel does not pass through the axis of rotation, if a central opening may be defined in the spool, a long drive shaft may be inserted through that central opening. Furthermore, if the spool does have a central opening, the spool may be used in a trimmer machine that has a short drive shaft. In some embodiments, the non-radial guide channel may be provided by engaging a guide channel module in the spool. The non-radial guide channel may be defined in the module. In other instances, the non-radial guide channel may be integrally formed as part of the spool itself.

The term non-radial may be understood to describe a guide channel or trimmer line conduit that extends across the bore of the spool's substantially cylindrical hub but does not extend along a radius of that hub. Non-radial should also be understood to describe a guide channel or trimmer line conduit that bypasses, passes around or does not extend through a center point or through a central axis of the hub. The central axis may be the one about which the spool may be rotatable. The term “around” as used herein should be understood to be in any desired direction from a central point of reference or in a circular or rounded course and should further be understood to include going upward, under, sideways, below, above etc. The term “non-radial” should be understood to describe a section of a trimmer line conduit or a guide channel that extends across the bore of a hub and may be not aligned along a radius of the hub. The term “non-radial” should further be understood to describe a section of a trimmer line conduit or the entire trimmer line conduit that may be offset from the central axis of the hub of the spool. Sections of the trimmer line conduit provided in the part of the flange, such as the funnels disclosed herein, may have regions that extend radially outwardly from the exterior surface of the hub or may be aligned along a radius of the hub but provided the portion that extends across the bore of the hub may be non-radial, it will be understood that this trimmer line conduit arrangement may be also considered to be non-radial because the funnels direct trimmer line toward a guide channel that is non-radial Routing a trimmer line through a non-radial guide channel or trimmer line conduit may be advantageous. This may be because this non-radial type of routing may somewhat increase the friction applied to the line which may be beneficial in positioning equal lengths of trimmer line between the guide channel openings.

The term “non-radial” should further be understood to be different from the term “radial”. The term “radial” should be understood to represent an orientation or position that extends substantially entirely along a radius of the spool's hub or is aligned with the radius of the spool's hub or passes through a center point or a center axis about which the spool rotates.

Preferably the spool of the present disclosure may be one that does not include a central opening for engaging a long driveshaft but is, instead, a spool used in a trimmer machine where a short driveshaft may be engaged with the housing instead of the spool. In other embodiments, the spool may include a hub that may define a central opening therein (i.e., an opening that may be positioned at the center point or center axis of the hub). The central opening may be provided for receiving and engaging a long driveshaft with the spool. In this latter instance, again, the guide channel may be non-radial and bypasses or passes around the center axis and therefore around the central opening. The provision of such a non-radial guide channel in the spool in accordance with the present disclosure makes it feasible to use the disclosed spool in trimmer machines that have either a long driveshaft or a short driveshaft. The use of a spool that may define a non-radial guide channel therethrough may be a benefit to original equipment manufacturers (OEMs) that manufacture trimmer machines with short and long driveshafts. The disclosed spool may be also of benefit to OEMs that manufacture, market and sell multi-fit replacement trimmer heads (i.e., universal trimmer heads) as an accessory product. The disclosed spools may provide a cost savings to these manufacturers as they may be able to use the same trimmer head or the same spool on long driveshaft or short driveshaft trimmer machines and no longer requires that the company make dedicated trimmer heads for the different trimmer machines.

The present disclosure relates to multiple embodiments of non-radial guide channels that may be incorporated into spools for trimmer machines. The types of trimmer machines that can use these spools with non-radial guide channels include manual trimmer heads, automatic dispensing trimmer heads, and semi-automatic dispensing trimmer heads. The non-radial guide channels may be utilized for preloading a length of trimmer line onto the spool of the trimmer head without removal of the spool from the trimmer head housing. The non-radial guide channel may take the form of a straight or linear guide channel or may be non-linear, i.e., angled or curved in some manner. A non-linear guide channel in the spool may be beneficial because the non-linear shape may apply a minimal amount of force against the trimmer line to hold the line in a relatively fixed position within the channel and thereby may prevent the line from moving out of position prior to winding the line into the storage compartments on the spool. In other words, the non-linear shape may aid in anchoring the trimmer line to the spool.

These and other objects of the present disclosure will be readily apparent upon review of the following detailed description and the accompanying drawings.

These objects of the present disclosure are not exhaustive and are not to be construed as limiting the scope of the claimed invention. Further, it may be understood that no one embodiment of the present disclosure need include all of the aforementioned objects. Rather, a given embodiment may include one or none of the aforementioned objects. Accordingly, these objects are not to be used to limit the scope of the claims.

In one aspect, the present disclosure may provide a spool for a vegetation trimmer machine comprising a cylindrical hub including a first end and a second end and having an interior surface and an exterior surface extending between the first and second ends; wherein the interior surface defines a bore; wherein the hub has a central axis about which the hub is rotatable; and wherein the hub is free of a central opening for receiving a driveshaft therein; at least one flange or a plurality of spokes extending radially outwardly from the exterior surface of the hub; and a trimmer line conduit provided in the spool, said trimmer line conduit including a guide channel that is non-radial and bypasses the central axis; and wherein said guide channel at least partially spans the bore of the hub. The spool may further comprise a first funnel defined in the at least one flange or the plurality of spokes; and a second funnel defined in the at least one flange or the plurality of spokes a distance circumferentially away from the first funnel; wherein the guide channel is in communication with the first and second funnels. The spool may further include a module that is received in the bore of the spool; and wherein the guide channel is defined at least partially in the module; and when the module is received in the bore, the guide channel is placed in communication with the first funnel and the second funnel. In another aspect the trimmer line conduit may be integrally formed with the spool.

In another aspect, the present disclosure may provide a method of engaging trimmer line in a spool of a trimmer machine comprising steps of providing a spool that has a cylindrical hub, wherein the spool is rotatable about a central axis of the hub and is free of a central opening for receiving a driveshaft of the trimmer machine therein; providing a guide channel in the spool that is non-radial and at least partially spans a bore defined by the hub, wherein the guide channel does not pass through the central axis; providing two openings in the spool that lead into the guide channel; providing a housing that receives said spool therein, wherein eyelets are formed in the housing; aligning said eyelets with said openings that lead to the guide channel; providing a length of trimmer line; inserting a first end of the trimmer line into a first one of the eyelets; advancing the trimmer line through the guide channel and out of a second one of the eyelets; and rotating the spool relative to the housing to wind trimmer line onto an exterior surface of the hub of the spool. In other aspects the disclosure may provide a method where the step of providing the non-radial guide channel in the spool comprises inserting a removable and replaceable module into a bore defined by an interior surface of the hub; wherein the module is free of a central opening for receiving the driveshaft of the trimmer machine therein; and forming at least a part of the non-radial guide channel in the module. The method may alternatively comprise integrally forming the guide channel with the spool.

In another aspect, the present disclosure may provide a method of loading trimmer line into a vegetation trimmer head; said method comprising providing a spool having a hub with at least one flange extending radially outwardly from an exterior surface of the hub; wherein an interior surface of the hub defines a bore; wherein the spool further defines a central opening adapted to receive a long driveshaft of a vegetation trimmer machine therethrough; and wherein the spool is rotatable about a central axis; providing a first module that at least partially defines a non-radial guide channel therein; inserting the first module into the bore of the spool; bypassing the central axis with the non-radial guide channel; placing the non-radial guide channel in fluid communication with a first funnel defined in a first region of the at least one flange and with a second funnel defined in a second region of the least one flange; forming a trimmer line conduit through the spool with the first funnel leading into the non-radial guide channel, leading into the second funnel; enclosing the spool in a cavity of a trimmer housing; engaging the trimmer head with a short driveshaft of a trimmer machine; aligning the trimmer line conduit with eyelets provided on the trimmer housing; advancing a length of trimmer line through a first one of the eyelets, through the trimmer line conduit; and through a second one of the eyelets; rotating the spool about the central axis; and winding the length of trimmer line onto the exterior surface of the hub. The method may further include forming, in the first module, a straight non-radial guide channel or a curved non-radial guide channel or a sinuous non-radial guide channel or a non-radial guide channel with two or more straight sections that intersect at an angle.

In another aspect, the present disclosure may provide a method of utilizing a same trimmer head spool in different vegetation trimmer machines, said method comprising providing a trimmer head spool including a cylindrical hub with a first end and a second end; wherein an interior surface of the hub defines a bore; and wherein the spool has at least one flange extending radially outwardly from an exterior surface of the hub; defining a trimmer line conduit through the spool, wherein the trimmer line conduit is partially defined in the at least one flange; wherein the trimmer line conduit includes a non-radial guide channel that at least partially spans the bore; wherein the guide channel is offset from or goes around a central axis about which the spool is rotatable; engaging the spool in a trimmer head housing; selecting a first vegetation trimmer machine that includes a long driveshaft or a second vegetation trimmer machine that includes a short driveshaft; engaging the trimmer head housing with the selected one of the first vegetation trimmer machine or the second vegetation trimmer machine; aligning eyelets provided in the trimmer head housing with the trimmer line conduit; advancing a length of trimmer line through a first one of the eyelets, through the trimmer line conduit and through a second one of the eyelets; rotating the spool about the central axis; and winding at least part of the length of trimmer line onto the exterior surface of the hub.

The step of defining the trimmer line conduit includes inserting a first module into the bore of the hub; wherein the first module at least partially defines the non-radial guide channel therein; wherein a top surface of the first module is substantially continuous and is free of a central opening for receiving a driveshaft therein; and wherein the step of selecting comprises selecting the second vegetation trimmer machine.

The step of defining the trimmer line conduit includes inserting a first module into the bore of the hub; wherein the first module at least partially defines the non-radial guide channel therein; and wherein the first module defines a central opening that extends from a top surface of the first module to a bottom surface thereof; and wherein the non-radial guide channel bypasses the central opening; wherein the step of selecting comprises selecting the first vegetation trimmer machine; and wherein the step of engaging the trimmer head housing includes inserting an end of the long driveshaft through the central opening of the first module and operatively engaging the end of the long driveshaft with the spool.

In another aspect, the step of defining the trimmer line conduit comprises at least partially integrally forming the trimmer line conduit in a wall of the spool that extends across the bore, wherein the wall is free of a central opening for receiving the long driveshaft therethrough; and wherein the step of engaging comprises engaging the trimmer head housing with the second vegetation trimmer machine with the short driveshaft.

In another aspect, the step of defining the trimmer line conduit in the wall includes providing the wall with a central opening and bypassing the central opening with the guide channel; wherein the step of engaging comprises engaging the trimmer head housing with the first vegetation trimmer machine; and inserting the long driveshaft through the central opening in the wall.

In yet another aspect, the present disclosure may provide a spool for a vegetation trimmer machine comprising a cylindrical hub including a first end and a second end and having an interior surface and an exterior surface extending between the first and second ends; wherein the interior surface defines a bore; wherein the hub has a central axis about which the hub is rotatable; and wherein the hub is free of a central opening for receiving a driveshaft therein; at least one flange or a plurality of spokes extending radially outwardly from the exterior surface of the hub; a first funnel defined in the at least one flange or the plurality of spokes; a second funnel defined in the at least one flange or the plurality of spokes a distance circumferentially away from the first funnel; wherein the guide channel extends between the first funnel and the second funnels; and a trimmer line conduit provided in the spool, said trimmer line conduit including a guide channel that is non-radial and bypasses the central axis; and wherein said guide channel spans the bore of the hub.

In yet another aspect, the present disclosure may provide a method of engaging trimmer line in a spool of a trimmer machine comprising steps of providing a spool that has a cylindrical hub, wherein the spool is rotatable about a central axis of the hub and is free of a central opening for receiving a driveshaft of the trimmer machine therein; providing a guide channel in the spool that is non-radial and at least partially spans a bore defined by the hub, wherein the guide channel does not pass through the central axis; providing two funnels in the spool that lead into the guide channel; providing a housing that receives said spool therein, wherein eyelets are formed in the housing; aligning said eyelets with said funnels that lead to the guide channel; providing a length of trimmer line; inserting a first end of the trimmer line into a first one of the eyelets; advancing the trimmer line into a first one of the two funnels, through the guide channel, through a second one of the two funnels; and out of a second one of the eyelets; and rotating the spool relative to the housing to wind trimmer line onto an exterior surface of the hub of the spool.

In yet another aspect, the present disclosure may provide a method of loading trimmer line into a vegetation trimmer head; said method comprising providing a spool having a hub with at least one flange or a plurality of spokes extending radially outwardly from an exterior surface of the hub; wherein an interior surface of the hub defines a bore; wherein the spool further defines a central opening adapted to receive a long driveshaft of a vegetation trimmer machine therethrough; and wherein the spool is rotatable about a central axis; providing a first module that at least partially defines a non-radial guide channel therein; wherein the first module is free of a central opening for receiving the long driveshaft therein; inserting the first module into the bore of the spool; bypassing the central axis with the non-radial guide channel; placing the non-radial guide channel in fluid communication with a first funnel defined in a first region of the at least one flange or the plurality of spokes and with a second funnel defined in a second region of the least one flange; forming a trimmer line conduit through the spool with the first funnel leading into the non-radial guide channel, leading into the second funnel; enclosing the spool in a cavity of a trimmer housing; engaging the trimmer head with a short driveshaft of a trimmer machine; aligning the trimmer line conduit with eyelets provided on the trimmer housing; advancing a length of trimmer line through a first one of the eyelets, through the trimmer line conduit; and through a second one of the eyelets; rotating the spool about the central axis; and winding the length of trimmer line onto the exterior surface of the hub.

In another aspect, the present disclosure may provide a method of utilizing a same trimmer head spool in different vegetation trimmer machines, said method comprising providing a trimmer head spool including a cylindrical hub with a first end and a second end; wherein an interior surface of the hub defines a bore; and wherein the spool has at least one flange or a plurality of spokes extending radially outwardly from an exterior surface of the hub; defining a trimmer line conduit through the spool, wherein the trimmer line conduit comprises a first flange and a second flange that are at least partially defined in the at least one flange or the plurality of spokes; wherein the trimmer line conduit includes a non-radial guide channel that extends between the first flange and the second flange and spans the bore; wherein the guide channel is offset from or goes around a central axis about which the spool is rotatable; engaging the spool in a trimmer head housing; selecting a first vegetation trimmer machine that includes a long driveshaft or a second vegetation trimmer machine that includes a short driveshaft; engaging the trimmer head housing with the selected one of the first vegetation trimmer machine or the second vegetation trimmer machine; aligning eyelets provided in the trimmer head housing with the trimmer line conduit; advancing a length of trimmer line through a first one of the eyelets, through the trimmer line conduit and through a second one of the eyelets; rotating the spool about the central axis; and winding at least part of the length of trimmer line onto the exterior surface of the hub.

### BRIEF DESCRIPTION OF THE SEVERAL VIEWS OF THE DRAWINGS

A sample embodiment of the disclosure may be set forth in the following description, may be shown in the drawings and may be particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a front elevation view of a lower end of an exemplary trimmer machine that includes a trimmer head and spool in accordance with an aspect of the present disclosure;

FIG. 1A is a perspective view of an alternative spool showing an insertable and replaceable spool engaged therewith;

FIG. 2 is an exploded front elevation view of a first embodiment of the trimmer head of FIG. 1;

FIG. 3 is an isometric perspective top view of an insertable and removable guide channel module that includes a first embodiment of a non-radial guide channel; wherein the guide channel module is selectively insertable in the spool of the trimmer head shown in FIG. 2;

FIG. 4 is an isometric perspective bottom view of the guide channel module of FIG. 3 and showing the first embodiment of a non-radial guide channel formed therein;

FIG. 5 is a top plan view of the spool taken along line 5-5 of FIG. 2 and rotated through ninety degrees clockwise and showing a bore into which the guide channel module is selectively insertable;

FIG. 6 is a top plan view of the guide channel module taken along line 6-6 of FIG. 2 and rotated through ninety degrees clockwise;

FIG. 7 is a top plan view of the spool, rotated through ninety degrees clockwise, showing the guide channel module engaged in the bore of the spool;

FIG. 8 is a horizontal cross-section of the spool and module shown in FIG. 7;

FIG. 9 is a horizontal cross-section of the trimmer head of FIG. 1, rotated through ninety degrees clockwise, showing the guide channel module assembled in the spool; and showing the spool assembled in the cavity of the housing and showing the path a trimmer line takes through the bore of the spool's hub via the non-radial guide channel;

FIG. 10A is an isometric perspective view of an alternative embodiment of a spool in accordance with the present invention; where the spool has a single storage compartment and is engaged with a knob; and wherein a second embodiment of an insertable and removable guide channel module having a second embodiment guide channel therein is shown engaged with the spool;

FIG. 10B is an exploded view of the spool, knob and module of FIG. 10A;

FIG. 11A is an isometric perspective top view of the second embodiment of the guide channel module shown in FIGS. 10A and 10B and which has a second embodiment of a non-radial guide channel formed therein;

FIG. 11B is an isometric perspective bottom view of the guide channel module of FIG. 11B showing the second embodiment non-radial guide channel;

FIG. 12 is an exploded front elevation view of a second embodiment of the trimmer head of FIG. 1;

FIG. 13 is a horizontal cross-section through a spool having a third embodiment of a non-radial guide channel integrally formed in one of the flanges thereof;

FIG. 14 is a horizontal cross-section of a spool having a fourth embodiment of a non-radial guide channel integrally formed in one of the flanges thereof;

FIG. 15 is a horizontal cross-section of a spool having a fifth embodiment of a non-radial guide channel integrally formed in one of the flanges thereof;

FIG. 16 is a horizontal cross-section of a spool having a sixth embodiment of a non-radial guide channel integrally formed in one of the flanges thereof;

FIG. 17 is a horizontal cross-section of a spool having a seventh embodiment of a non-radial guide channel integrally formed in one of the flanges thereof;

FIG. 18 is a horizontal cross-section through a trimmer head that includes a spool engaged in a housing, where the spool has an eighth embodiment of a non-radial guide channel integrally formed therein and showing an end of a length of trimmer line being inserted into the trimmer head;

FIG. 19 is a horizontal cross-section through a trimmer head that may include a spool engaged in a housing, where the spool has an ninth embodiment of a non-radial guide channel integrally formed therein and showing an end of a length of trimmer line being inserted into the trimmer head;

FIG. 20A is a horizontal cross-section of a spool having a tenth embodiment of a guide channel integrally formed therein;

FIG. 20B is a front elevation view of the spool of FIG. 20A showing the configuration of the funnel and trimmer line guide and showing the cross-sectional shape of the guide channel;

FIG. 21A is a horizontal cross-section of a spool having an eleventh embodiment of a guide channel integrally formed therewith;

FIG. 21B is a front elevation view of the spool of FIG. 21A showing the configuration of the funnel and trimmer line guide and showing the cross-sectional shape of the guide channel;

FIG. 22A is a horizontal cross-section of a spool having an twelfth embodiment of a guide channel integrally formed therewith;

FIG. 22B is a front elevation view of the spool of FIG. 22A showing the configuration of the funnel and trimmer line guide and showing the cross-sectional shape of the guide channel;

FIG. 22C is a rear elevation view of the spool of FIG. 22A showing the configuration of the funnel and trimmer line guide and showing the cross-sectional shape of the guide channel;

FIG. 23A is a horizontal cross-section of a spool having a thirteenth embodiment of a guide channel integrally formed therewith;

FIG. 23B is a front elevation view of the spool of FIG. 23A showing the configuration of the funnel and trimmer line guide and showing the cross-sectional shape of the guide channel;

FIG. 23C is a rear elevation view of the spool of FIG. 23B showing the cross-sectional shape of the guide channel;

FIG. 24A is a horizontal cross-section of a spool having a fourteenth embodiment of a guide channel integrally formed therewith; and

FIG. 24B is a front elevation view of the spool of FIG. 24A showing the configuration of the funnel and trimmer line guide and showing the cross-sectional shape of the guide channel.

Similar numbers refer to similar parts throughout the drawings.

### DETAILED DESCRIPTION

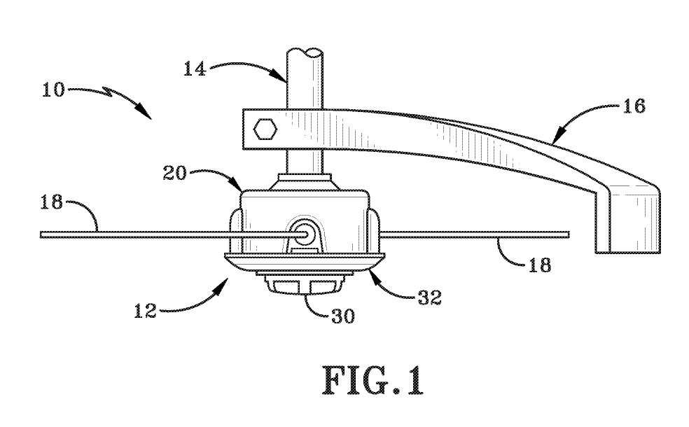

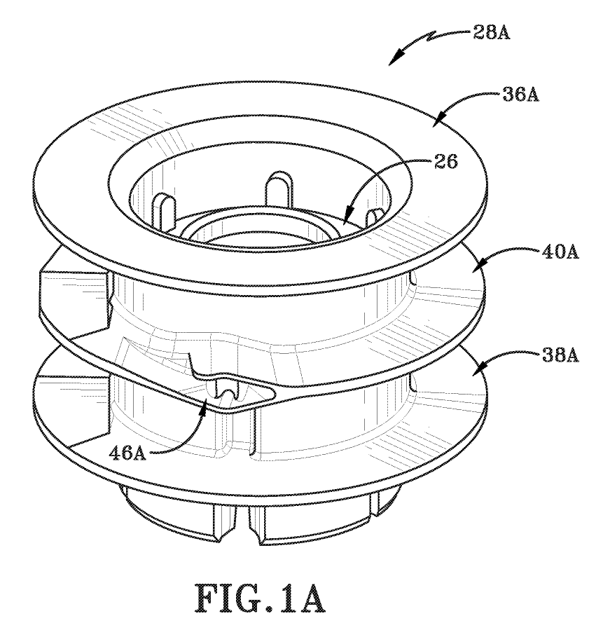

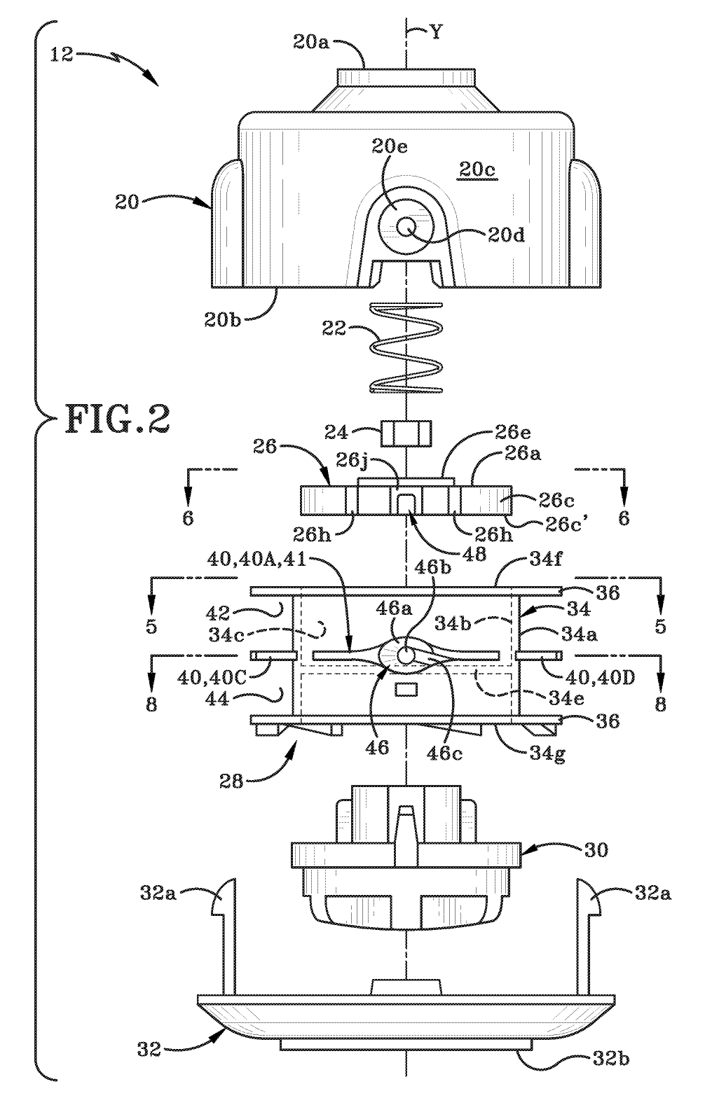

FIG. 1 shows and end of one type of trimmer machine 10 that may include a trimmer head 12, a shaft 14 engaged with the trimmer head 12 and an optional debris shield 16 mounted on shaft 14. Although not shown in the attached figures, trimmer machine 10 may include a motor and a steering handle. Shaft 14 may be hollow and, within the hollow portion, shaft 14 may contain a mechanical connection (which may be referred to as a driveshaft) that couples the motor to trimmer head 12. Since shaft 14 may include the driveshaft therein, the reference number 14 as used herein will be used to denote both the shaft and the driveshaft. The motor, when actuated, rotates driveshaft 14 and the driveshaft 14 in turn rotates trimmer head 12 about a central axis “Y” (FIG. 2). The steering handle referenced above may be engaged with an upper end of shaft 14 and may be held by an operator to hold, guide and direct trimmer machine 12.

It should be understood that the configuration of trimmer machine 10 is provided merely as an example of one type of trimmer machine 10 with which trimmer head 12 may be engaged. It should be understood, however, that the shape, components, function and method of operation of the trimmer machine may be different from what is illustrated in FIGS. 1, 3 and 12 and the illustrated configuration of trimmer head 12 and trimmer machine 10 should therefore not be considered as limiting to the present invention. For example, the driveshaft with which trimmer head 12 may be engaged may be a long, straight driveshaft or a short curved driveshaft. Trimmer head 12 may be of the type that includes a bump knob that is engaged with the ground in order for trimmer line to be dispensed therefrom. In other instances, trimmer head 12 may not included the bump knob but the trimmer line may, instead, be advanced by tapping the bottom of the actual housing on the ground. Other components may be included or omitted from trimmer head 12 from what is illustrated in the attached figures.

Trimmer head 12 may connect via the driveshaft to a distal end of shaft 14 in any suitable manner. Trimmer head 12 may be used with other types of trimmers other than the illustrated trimmer machine 12. For example, although vegetation trimmer 12 may be illustrated as a handheld machine, an embodiment of a trimmer head 12 may be used on a wheeled trimmer machine.

As used herein, the terms “top” and “bottom”, “upper” and “lower” refer to the relative positions that the top and bottom or upper and lower parts of trimmer head 12 would assume when trimmer head 12 is in use or while operating when attached to shaft 14.

Two sections of trimmer line 18 extend outwardly from trimmer head 12. Trimmer head 12 may include a spinning portion that causes the free ends of trimmer line 18 to rotate at a fast enough speed to cut vegetation. Trimmer line 18 may be a flexible wire. For example, trimmer line 18 may be a nylon wire or other type of wire. As trimmer head 12 spins, the ends of trimmer line tend to extend radially outward as a result of the centrifugal force. In an embodiment, trimmer line 18, may be any of a wide range of both different sizes (e.g. 0.047″ to 0/160″ in diameter) and be of different shapes, such as round or no-round cross-sections (e.g., square, octagonal, hexagonal, diamond-shaped or oval). Trimmer line 18 may, for example, be any trimmer line constructed as a flexible yet rugged filament, string or wire. In an embodiment, trimmer line 18 may be any of the commercially available flexible monofilament plastic trimmer lines of any suitable type and cross-section configuration, such as 0.065″, 0.080″, 0.095″, 0.105″, 0.12″ gauge nylon trimmer line or the like, which may be currently used as cutting filament in conventional vegetation trimmer heads.

Debris shield 16 may be provided to help protect the operator from flying debris that may be kicked up by ends of trimmer line 18 during use of trimmer machine 12. Debris shield 16 may include a trimmer line cutter blade which helps maintain the length of trimmer line 18 that extends outwardly from trimmer head 12. The cutter blade helps maintain the two trimmer lines sections that extend outwardly from trimmer head 12 at a substantially equal length to each other.

Referring to FIG. 2, trimmer head 12 may comprise an upper housing 20, a spring 22, a nut 24, a guide channel module 26, a spool 28, a knob 30 and a bottom housing 32. (In other instances, trimmer head 12 may not include the knob 30 and bottom housing 32 may be differently configured.) The central axis “Y” may be shown extending through trimmer head 12. Axis “Y” may be the axis about which upper housing 20 and spool 28 may be rotated when trimmer machine 10 is actuated. The actual direction of rotation of spool 28 about central axis “Y” may be determined by the particular trimmer machine's construction. In some trimmer machines, the driveshaft 14 may rotate in a clockwise direction while in other trimmer machines the driveshaft may rotate in a counterclockwise direction.

Trimmer head 12 and some or all of the other parts utilized in trimmer machine may be made by injection molding high grade plastic materials (e.g., nylon and glass filled nylon) that may be light in weight. Alternatively, some or all of the trimmer head and the other parts may be fabricated by cast aluminum or other metals.

It should be understood that the non-radial guide channels disclosed herein are not limited to being incorporated into just one specific trimmer head design, they can be incorporated into many existing and future easy load spool trimmer heads.

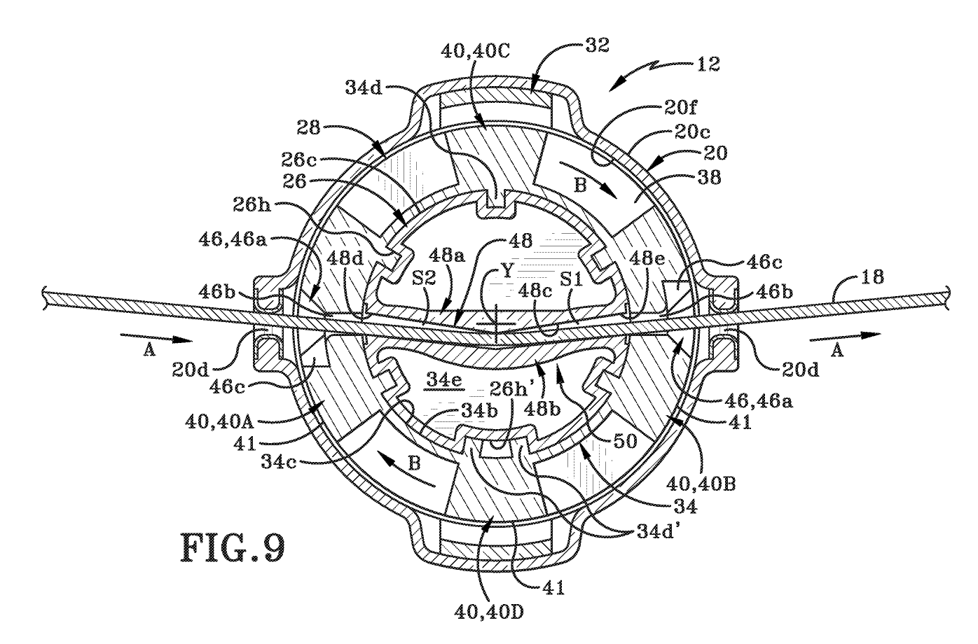

Still referring to FIG. 2, upper housing 20 may include a first end 20a, a second end 20b and a skirt 20c that extends between first end 20a and second end 20b. First end 20a may define a first opening therein and through which an end of driveshaft 14 may be received. Skirt 20c may define a pair of eyelets 20d therein that are spaced a distance circumferentially away from each other on housing skirt 20c. In many or most instances, eyelets 20d may be diametrically opposed to each other. Each eyelet 20d may be circumscribed by a reinforcing ring 20e. Second end 20b of upper housing 20 may define and circumscribes a second opening that may be in communication with a central cavity 20f (FIG. 9) that may be bounded and defined by first end 20a and skirt 20c. Spool 28 may be configured to be received into central cavity 20f through the second opening. The first opening defined in first end 20a, the second opening defined in the second end 20b and eyelets 20d defined in skirt 20c may all be in communication with central cavity 20f of upper housing 20.

A bottom housing 32 may be configured to latch to upper housing 20 and close off access to the second opening in upper housing 20 and thereby to the central cavity 20f. Bottom housing 32 may include a pair of latching members 32a that extend upwardly therefrom. Latching members 32a may be configured to be selectively engaged with complementary cooperating members defined in an interior surface of skirt 20c. Although not illustrated herein, bottom housing 32 may define a third opening that may be defined in a second end 32b thereof. The third opening may be located, shaped and sized to receive a portion of knob 30 therethrough. Knob 30 may be configured to be operatively engaged with spool 28. When spool 28 and a portion of knob 30 are received in the central cavity defined by upper housing 20, bottom housing 32 may be latched to upper housing 20 in order to retain spool 28 and knob 30 in place. A portion of knob 30 may extend outwardly through the third opening defined in the bottom housing 32. When knob 30 may be rotated, trimmer line 18 may be wound onto spool 28 while spool 28 remains within central cavity 20f of upper housing 20. There may therefore be no need to remove bottom housing 32 in order to access spool 28 to wind a new length of trimmer line 18 thereon.

The present disclosure may be directed to a non-radial guide channel and to a trimmer line conduit that may include the non-radial guide channel. The present disclosure may further be directed to a spool that may include the non-radial guide channel and the trimmer line conduit; and may still further be directed to a trimmer head including the spool having the non-radial guide channel. The non-radial guide channel, the trimmer line conduit, and the spool will be discussed in greater detail below. It should be understood, however, that many features of the spool that are unrelated to the guide channel may be differently configured from how those features are shown in the attached figures. Similarly, many features on the trimmer head may be varied if they are unrelated to the trimmer line conduit or guide channel provided in the spool of the trimmer head.

It should further be noted that trimmer head 12 and spool 28 are of a type that when a length of trimmer line 18 may be to be wound onto the spool 28, then the spool may remain fully engaged and secure within trimmer head 12. There may be no need to disassemble trimmer head 12 in order to gain access to spool 28 when it may be desired to wind new trimmer line 18 thereon.

The non-radial guide channel may be provided in spool 28 in two different ways, namely, on the module 26 that may then be engaged with spool 28 or as an integrally formed part of the spool 28. In the latter instance, the trimmer head will be substantially identical to trimmer head 12 shown in FIG. 2 except that the module 26 may be omitted therefrom. In each instance, the non-radial guide channel may be provided so that the guide channel spans a bore defined by the spool.

The term “spans” as used herein is used to indicate that the guide channel may extend through, over or across the bore from one region of the interior surface of the hub of the spool to another region of the interior surface of the hub of the spool. In some embodiments, the guide channel may be considered to be a type of bridge that extends across the bore and links one region of the hub to another.

The phrase “at least partially spans” is used herein to indicate that the guide channel may originate in one region of the interior surface of the hub of the spool and extend inwardly into the bore for a distance but where the guide channel may not terminate in another region of the interior surface of the hub.

At least the portion of spool 28 that defines trimmer line conduit 50 and particularly guide channel 48 may be rigid in construction, i.e., not flexible. The trimmer line conduit 50 that may include the non-radial channel may be brought into alignment with eyelets 20d on upper housing 20 in order to load a length of trimmer line onto the spool. An end of a length of trimmer line 18 may be inserted through one eyelet 20d and into the trimmer line conduit, may be threaded through the trimmer line conduit and subsequently exits the trimmer line conduit and passes through the other eyelet 20d. The trimmer line 18 may be pulled through the conduit to a sufficient degree so that substantially equal lengths of line extend outwardly from each eyelet. The user will then actuate the knob or any other similar mechanism and rotating the same will cause the spool 28 to rotate about central axis “Y” and wind the trimmer line lengths onto the spool 28.

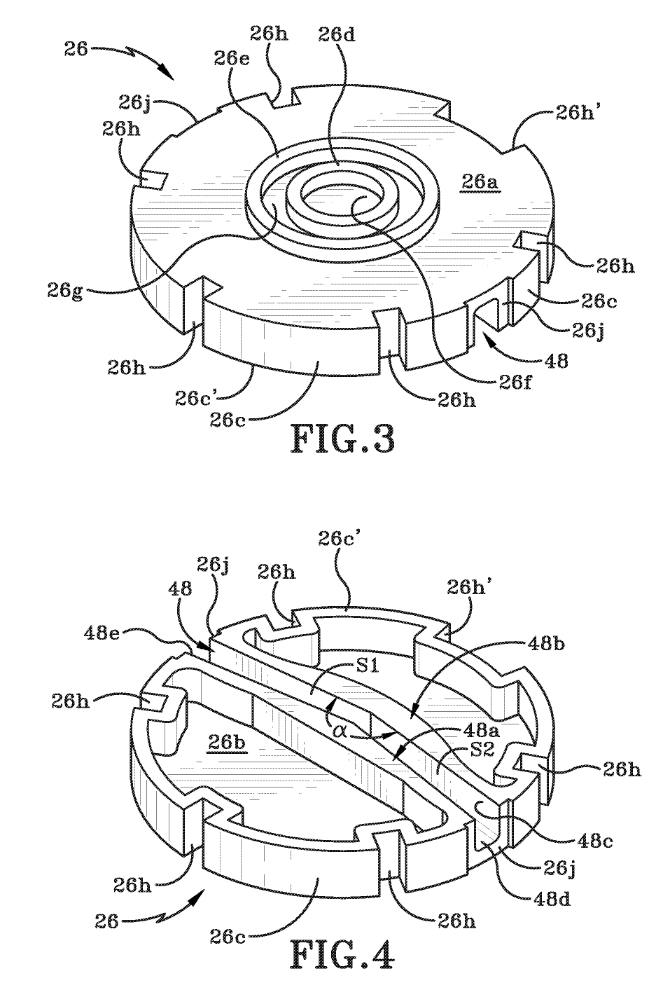

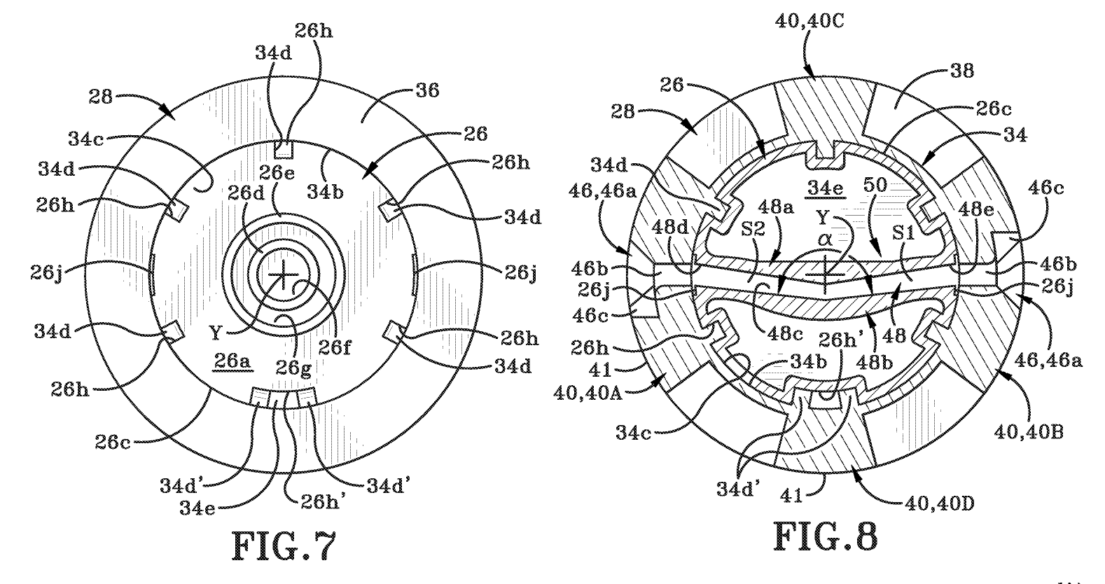

This disclosure sets out a number of differently configured guide channels; some in replaceable modules 26 and some as integral parts of the spool 28. It should be understood, however, that each of the guide channel embodiments shown as part of a module 26 could, instead, be integrally formed in the spool 28; and that each of the guide channel embodiments shown as an integral part of spool 28 could instead be provided on module 26. In addition to each embodiment illustrated in FIGS. 3 to 24B, the other components of the trimmer machine 10 shown in FIGS. 1 and 2 are substantially identical in structure and function and therefore will not be specifically discussed in relation to each embodiment but will apply equally to all embodiments.

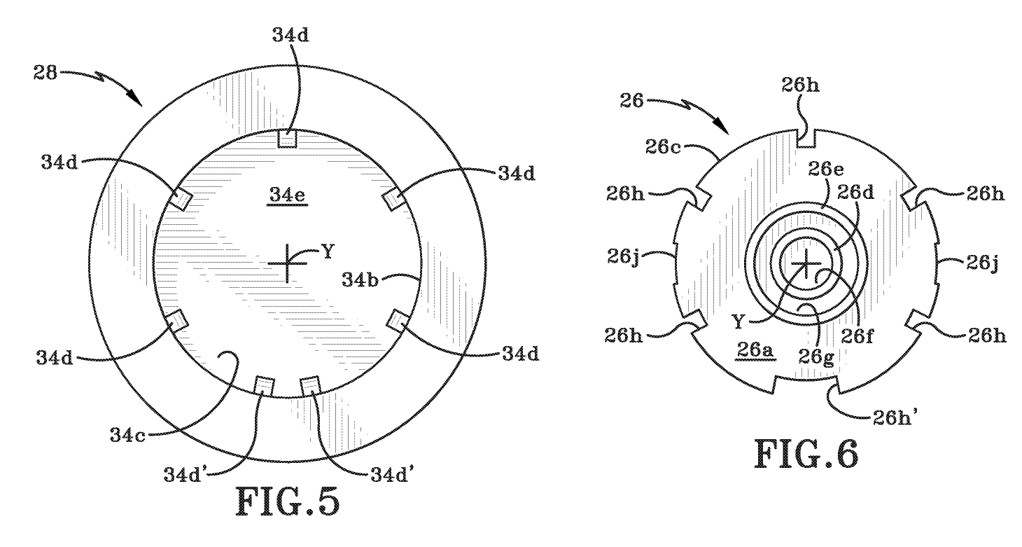

Referring still to FIG. 2 and additionally to FIGS. 5 and 8, spool 28 may comprise a cylindrical hub 34 having an exterior surface 34a and an interior surface 34b (FIG. 8). The interior surface 34b may bound and define a bore 34c. A plurality of detents 34d (FIG. 5) may extend outwardly from interior surface 34b and into bore 34c. Detents 34d may be oriented to be generally parallel to central axis “Y” and may be located at intervals around the circumference of interior surface 34b. Detents 34d may correspond with offset vertical projections located in the interior of upper housing 20, which are commonly known as a dog clutch, and are used for the purpose of indexing and limiting an amount of trimmer line that may be dispensed from upper housing 20 each time knob 30 may be tapped or bumped on the ground. Detents 34d, in accordance with an aspect of the present disclosure, may also be used to help position and retain guide channel module 26 in engagement with spool 28. This will be later described herein.

A wall 34e may extend across bore 34c a distance inwardly from each of a first end 34f and a second end 34g of hub 34. Wall 34e may be substantially continuous and may not include any openings therethrough. In particular, wall 34e is free of or does not include a central opening through which an end of driveshaft 14 may pass.

Spool 28 may further include one or more flanges that radially extend outwardly from exterior surface 34a of hub 34. FIG. 2 shows that spool 28 may include a first flange 36 located proximate first end 34f of hub 34, a second flange 38 located proximate second end 34g of hub 34, and an intermediate flange 40. The specific configuration of flanges 36 and 38 may be not of particular relevance to the present disclosure. Suffice to say, that any desired configuration of flanges 36, 38 may be utilized on spool 28 to suit the type of trimmer machine 10, upper housing 20 or knob 30 with which spool 28 may be to be engaged. As shown in FIG. 2, a plurality of evenly spaced projections 38a may extend outwardly from a lower surface of second flange 38. Projections 38a may engage with depressions or vertical projections provided in an interior of bottom housing 32 and prevent spool 28 from rotating if knob 30 may be pressed inward against mechanical bias during operation. Consequently, during operation spool 28 may only release trimmer line 18 when spool 28 may be not resting on the top of bottom housing 32 or on the bottom of top housing 20. This may limit how much trimmer line 18 may be released during operation by tapping or bumping button 30.

A first storage compartment 42 for receiving wound trimmer line 18 may be defined between first flange 36, exterior surface 34a of hub 34 and intermediate flange 40. A second storage compartment 44 for receiving wound trimmer line 18 therein may be defined between intermediate flange 40, exterior surface 34a of hub 34 and second flange 38.

Intermediate flange 40 may comprise a substantially continuous annular ring, or a plurality of discrete, spaced apart arms, or a plurality of spokes, or a plurality of spokes that are connected at their outermost ends by an annular ring. The term arm, spoke or flange may be used interchangeably herein. The arms or spokes may extend outwardly from the exterior surface 34a of hub 34 and terminate a distance away therefrom. FIGS. 2 and 8 show four discrete arms or spokes of flange 40, with the arms being identified as arms 40A, 40B, 40C and 40D. In other embodiments (not shown), intermediate flange may comprise fewer than four discrete arms or more than four discrete arms. Intermediate flange 40 (i.e., one or more of arms 40A, 40B, 40C and 40D) may have an outer edge 41 that may be spaced a distance outwardly from exterior surface 34a of hub 34.

FIG. 1A shows an alternative embodiment of spool that may be used in trimmer machine 10. This alternative spool may be identified by the reference number 28A. Spool 28A may include a hub 34A and has a first flange 36A, a second flange 38A and an intermediate flange 40A extending radially outwardly from an exterior surface of hub 34A. The intermediate flange 40A may comprise a substantially continuous annular ring that extends outwardly from the circumferential exterior surface of hub 34A. An insertable and replaceable module 26 may be engaged in a bore defined by an interior surface of hub 34A. All other components of spool 28A may be substantially identical in structure and function to spool 28.

It will be understood that the arm-version of flange 40 shown in FIG. 1 may be utilized in any of the spools illustrated in FIGS. 1-24B or, alternatively, the annular ring version of flange 40A shown in FIG. 1A may be utilized in any of the spools illustrated in FIGS. 1-24B. It should further be understood that the arm type construction may be utilized in one, more or all of the first flange 36, the second flange 38, or the intermediate flange 40 and there may be one or more of the annular type flanges provided in the spool. The spool 28, 28A may be fabricated in any way that will enable the guide channel module 26, 26A to be substantially coplanar with any of the first flange 36, 36A; the second flange 38, 38A or the intermediate flange 40, 40A.

Referring again to FIG. 1, each of the opposed intermediate arms 40A, 40B defines an opening 46 (FIG. 8) in the outer edge thereof and each opening extends inwardly towards hub 34. The openings 46 may take any of a number of different configurations as will be discussed later herein. Openings 46 may be spaced a distance circumferentially from each other and may particularly be diametrically opposed to each other (as illustrated in FIG. 8). In other instances, the two openings 46 may be located at any other desired position on intermediate flange 40 relative to each other. When spool 28 may be received in the central cavity 20f (FIG. 9) of upper housing 20, openings 46 may be generally aligned with eyelets 20d in upper housing 20.

As best seen in FIGS. 2 and 8, each opening 46 may include a funnel 46a, a tubular region 46b, and a trimmer line guide 46c. Funnel 46a may originate at the outer edge 41 of flange 40 and taper inwardly towards exterior surface 34a of hub 34. In other words, funnel 46a tapers in the direction in which an end of trimmer line 18 would be inserted into funnel 46a and subsequently into guide channel 148. Funnel 46a thus becomes gradually narrower in width and shorter in height as one moves inwardly towards hub 34. Funnel 46a may also be shaped and sized to overlap one of the eyelets 20d on upper housing 20 when spool 28 may be engaged in upper housing 20. Tubular region 46b extends inwardly from a narrowest part of funnel 46a and terminates in an opening defined in the interior surface 34b of hub 34. It will be understood that even at the smallest dimensioned portion of funnel 46a where tubular region 46b originates, the funnel 46a may still be larger than an exterior diameter of trimmer line 18 that may be wound onto spool 28. Tubular region 46b may be of a substantially constant diameter along its length from the funnel 46a to interior surface 34b. The diameter of tubular region 46b is, again, larger than the exterior diameter of trimmer line 18. Trimmer line 18 therefore free to move through funnel 46a and through tubular region 46b and will not become wedged or trapped therein because the entire opening 46 may be of a larger diameter than the trimmer line. Funnel 46a of each opening 46 at outer edge 41 may be of a greater dimension than the associated eyelet 20d in upper housing 20. This ensures that there will be overlap between eyelet 20d and opening 46 so that trimmer line 18 may be inserted therethrough. There does not have to be exact alignment between eyelet 20d and opening 46.

Trimmer line guide 46c may be formed by a radially shorter wall section of funnel 46a on a side of a plane of flange 40. Trimmer line guide 46c may extend circumferentially outwardly from an outermost part of funnel 46a and may further extend for a distance along outer edge 41 of flange 40. Trimmer line guide 46c may further extend for a distance inwardly towards hub 34 and angle either upwardly towards first storage compartment 42 or downwardly towards second storage compartment 44. Each trimmer line guide 46c directs trimmer line 18 into one other storage compartments 42, 43 during winding of trimmer line 18 onto spool 28.

The two openings 46 are mirror images of each other so that trimmer line 18 may be fed simultaneously into first and second storage compartments 42, 44. As can be seen in FIG. 2, trimmer line guide 46c of the opening 46 in arm 40A angles downwardly from the funnel 46a towards second storage compartment 44. Although not illustrated herein, it will be understood that the trimmer line guide 46c of the opening 46 in arm 40B may be a mirror image of the opening 46 in arm 40A and angles upwardly away from the funnel 46a and towards first storage compartment 42.

Referring to FIGS. 8 and 9, in particular, it should be noted that while the guide channel 48 is non-radial, a portion of each funnel 46 may be aligned with the radius of the hub. The portions of the funnels 46 that do align with the radius of the spool are thereby alignable with the eyelets 20d (FIG. 9) defined in the housing 20. Consequently, when an end of trimmer line 18 is inserted into one of the eyelets 20d and the user pushes on the trimmer line 18 to cause trimmer line 18 to move through guide channel 48; the funnel 46 will direct the end of trimmer line 18 (and thereby all of the trimmer line 18) into a non-radial pathway that is dictated by the non-radial guide channel 48.

A first embodiment of a guide channel module 26 in accordance with the present disclosure may be shown in FIGS. 3-6. Module 26 may be a disc-like object that has a first end 26a, a second end 26b, and a peripheral wall 26c. Peripheral wall 26c originates at first end 26a and extends for a distance outwardly beyond second end 26b. This can be seen in FIG. 4. Second end 26b may therefore be recessed relative to an outermost end 26c′ of peripheral wall 26c. Guide channel module 26 does not include any central opening in first and second ends 26a, 26b through which a region of driveshaft 14 might pass when guide channel module 26 may be received in bore 34c of spool 28. When guide channel module 26 may be engaged with spool 28, outermost end 26c′ of guide channel module 26 rests on wall 34e of spool 28. Guide channel module 26 and wall 34e therefore effectively block bore 34c of spool 28. When module 26 may be placed on wall 34e, the guide channel 48 defined by module 26 aligns with funnels 46 in intermediate flange 40 and thus forms a trimmer line conduit 50 through which trimmer line 18 may be routed through spool 28.

Guide channel module 26 may include a pair of concentric annular rings 26d, 26e that extend upwardly and outwardly from first end 26a. Ring 26d may bound and define a central region 26f. Ring 26e may be spaced a distance radially outwardly from ring 26d such that a space 26g may be defined between the rings 26d, 26e. Driveshaft 14 may extend through the first opening in upper housing 20 and be secured thereto by nut 24. Spring 22 may be seated at one end in space 26g on module 26 and at the other end in a complementary region of the interior surface of upper housing 20. Spring 22 may urge module 26 into contact with wall 34e of spool 28.

Wall 26c of guide channel module 26 may define a plurality of slots 26h therein. Each slot 26h may extend from first end 26a to outermost end 26c′ and the various slots 26h may be located at positions around the circumference of wall 26c that correspond to the positions of the detents 34d in hub 34. Slots 26h may be complementary to detents 34d. Spool 28 may also be provided with a keyseat 34d′ and module 26 may be provided with a keyway 26h′ (or vice versa). When guide channel module 26 may be received within bore 34c of spool 28, slots 26h may be aligned with detents 34d and keyway 26h′ may be aligned with keyseat 34d′ After this alignment, module 26 may be moved downwardly into bore 34c and detents 34d are received in slots 26h, and keyway 26h′ may be received in keyseat 34d′. Module 26 may thereby be interlockingly engaged with spool 28 in such a way that rotation of module 26 within bore 34c of spool 28 may be substantially prevented. The presence of keyseat 34d′ and keyway 26h′ helps ensure that module 26 may only be received in bore 34c in a single orientation.

Second end 26b of guide channel module 26 may define at least a portion of a guide channel therein. Another portion of the guide channel may be provided by a surface of wall 34e of spool 28. FIG. 4 shows a first embodiment of a guide channel in accordance with an aspect of the present invention, generally indicated by the reference number 48. Guide channel 48 may be non-radial and may be additionally non-linear along its length one region of outer edge 26c to another region of outer edge 26c. Guide channel 48 may be formed by two spaced apart walls 48a, 48b that extend outwardly away from second end 26b of module 26. Walls 48a, 48b may be laterally spaced apart from each other and define a gap 48c therebetween. Guide channel 48 may be bounded and defined by a portion of second end 26b and interior surfaces of walls 48a, 48b. Guide channel 48 may have an entrance opening 48d defined in peripheral wall 26c and an exit opening 48e defined in peripheral wall 26c a distance away from entrance opening 42d. It will be understood that the terms “entrance opening” and “exit opening” are being utilized herein for ease of explanation only and should not be construed as limiting how trimmer line 18 may be introduced into guide channel 48 or how trimmer line 18 exits guide channel 48. Each of the entrance opening 48d and exit opening 48e may be located in a notch 26j defined in peripheral wall 26c of guide channel module 26. Entrance opening 48d and exit opening 48e (and their associated notches 26j) may be located on guide channel module 26 where openings 48d, 48e are able to be aligned with the openings of tubular regions 46b that are defined in interior surface 34b of hub 34 when module 26 may be inserted into spool 28. This may be illustrated in FIG. 8.

In particular, module 26 may be inserted into bore 34c such that first end 26a of module 26 faces first flange 36 and second end 26b faces second flange 38. Guide channel 48 may be generally U-shaped when viewed from either the entrance or exit openings 48d, 48e. When module 26 may be engaged with spool 28, module 26 sits upon wall 34e that extends across the bore 34c of spool 28. A portion of this wall 34e closes off access to gap 48c of guide channel 48 and guide channel 48 may consequently be substantially square or rectangular in cross-section when viewed from either of the entrance or exit openings 48d, 48e. In other words, guide channel may be polygonal in cross-section.

In accordance with an aspect of the present disclosure, guide channel 48 may be a non-radial guide channel and, in particular, may be an angular, non-linear guide channel. In other words, guide channel 48 does not pass through a center point of guide channel module 26 and therefore does not pass through a center point of spool 28. The center point may be identified by the reference number “Y” to indicate that when module 26 may be installed in spool 28, the central axis “Y” may pass through the center point of module 26. Not only may guide channel 48 be non-radial but the guide channel 48 may be comprised of a first section “S1” and a second section “S2” that are oriented at an angle a (FIG. 4) relative to each other and therefore guide channel 48 may be not straight, i.e., non-linear along its entire length. First section and are each, however, substantially straight (or linear) along their individual lengths. Each of the first section “S1” and second section “S2” may be substantially wider proximate the associated openings 48d or 48e, respectively, and narrower where the first and second sections “S1”, “S2” meet. It should be noted that even at its narrowest point the cross-section of guide channel 48 may be still of greater size than the trimmer line 18 that may be threaded therethrough. Consequently, trimmer line 18 may be free to be moved through guide channel 48 when loading spool 28.

When trimmer head 12 may be assembled, guide channel module 26 may be received in a bore defined by spool 28 and an end of driveshaft 14 may be inserted through the first opening in first end 20a of upper housing 20. Spring 22 may be positioned around the end of driveshaft 14 and nut 24 may be engaged with the end of driveshaft 14 to secure upper housing 20 to driveshaft 14.

FIG. 9 shows guide channel module 26 installed in bore 34c of spool 28; and further shows spool 28 installed in central cavity 20f of upper housing 20. FIG. 9 further shows the path trimmer line 18 takes through hub 34. As can be seen in this figure, detents 34d on hub 34 are captured in the slots 26h defined in guide channel module 26. Additionally, housing 18 and spool 28 are positioned such that eyelets 20d are generally aligned with funnels 46a of the openings 46 defined in arms 40A and 40B. When module 26 may be installed in bore 34c in the single orientation dictated by keyway 26h′ and keyseat 34d′, entrance and exit openings 48d, 48e of guide channel 48 align with the openings of the tubular regions 46b in interior surface 34b of hub 34. Guide channel 48 and openings 46 together form a trimmer line conduit 50 that may be in communication with eyelets 20d. Trimmer line conduit 50 thus comprises a funnel 46a that leads into a tubular region 46b that leads into an opening 48e that leads into a straight section “S2” that leads into a straight section “S1” oriented at an angle to “S2”, that leads into an opening 48d, that leads into tubular region 46b, that leads into funnel 46a. Consequently, trimmer line 18 may be inserted through first eyelet 20d, and may be advanced through funnel 46a, may be advanced through tubular region 46b, may be advanced through second section “S2”, may be advanced through first section “S1”, may be advanced through tubular region 46b, may be advance through the second funnel 46a and out of the second eyelet 20d. Alternatively, trimmer line 18 may be advanced through trimmer guide conduit 50 in reverse order from what may be indicated above. It should be noted that tubular regions 46b may be linearly aligned with each other.

Referring still to FIG. 9, in order to wind trimmer line 18 onto spool 28, an end of a length of trimmer line 18 may be inserted through one of the eyelets 20d in upper housing 20 and may be captured and directed by the adjacent funnel 46a in the arm 40A (for example) of spool 28 into the associated tubular region 46b. As indicated earlier herein, since funnels 46a, 46b at least partially overlap the eyelets 20d, the alignment of the eyelets 20d and openings 46 does not have to be exact. The end of the trimmer line 18 passes through the tubular region 46b, out of the opening defined in interior surface 34b of hub 34 and into the adjacent opening 48e of guide channel 48. The end of the trimmer line 18 advances, in the direction of arrow “A”, through second section “S2” of guide channel 48. When the end of the length of trimmer line 18 strikes the surface of wall 48b, the end of trimmer line 18 rides along that surface and may be deflected into first section “S1” of guide channel 48. Trimmer line 18 advances through first section “S1”, out of opening 48d and into the opening to the opposed tubular region 46b defined in interior surface 34b of hub 34. Trimmer line 18 moves through tubular region 46b in arm 40A, through funnel 46a and out of the adjacent eyelet 20d. The direction of threading of trimmer line 18 may be indicated by arrow “A” in FIG. 9 but it will be understood that the direction of threading could be in the opposite direction to that indicated by arrow “A”. A length of trimmer line 18 may be pulled through trimmer line conduit 50 until substantially equal lengths of trimmer line 18 extend from both eyelets 20d.

In order to wind trimmer line 18 into first and second storage compartments 42, 44, the spool 28 may be rotated in the direction indicated by arrow “B” in FIG. 9, for example. As spool 28 starts to rotate, trimmer line guides 46c may direct one section of trimmer line 18 towards first storage compartment 42 and the other section of trimmer line 18 towards second storage compartment 44. Passing trimmer line 18 through guide channel 48 and initiating the rotation of spool 28 may cause a section of trimmer line 18 to become anchored to spool 28. Continued rotation of spool 28 may cause trimmer line 18 to be progressively wound onto the exterior surface 34a of hub 34. The angled storage compartment guides 46c may ensure a length of trimmer line 18 extending outwardly from one of the openings 48d may be wound into first storage compartment 42 and the other section of trimmer line 18 extending outwardly from the other opening 48e may be wound into second storage compartment 44.

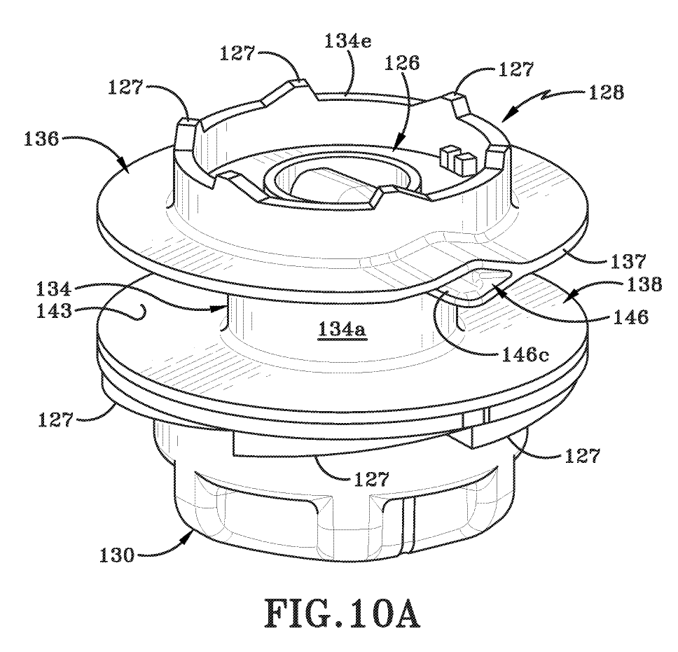

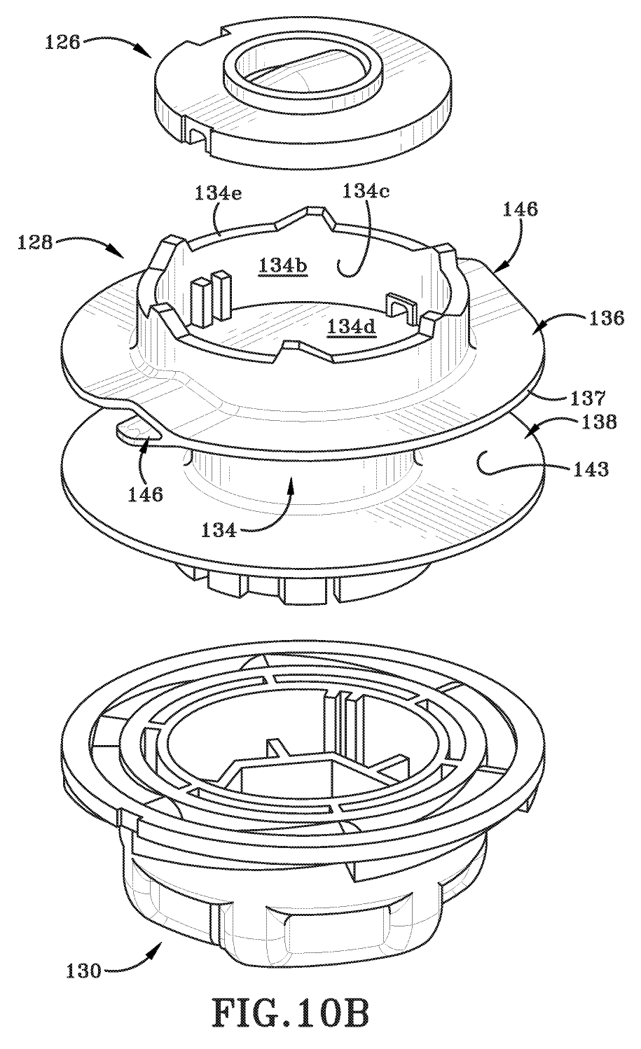

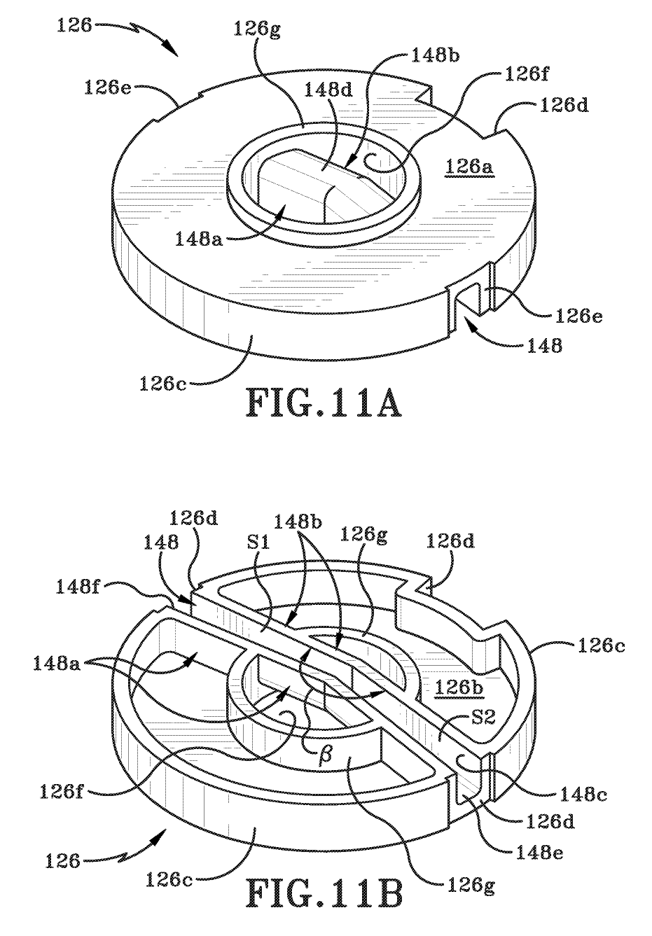

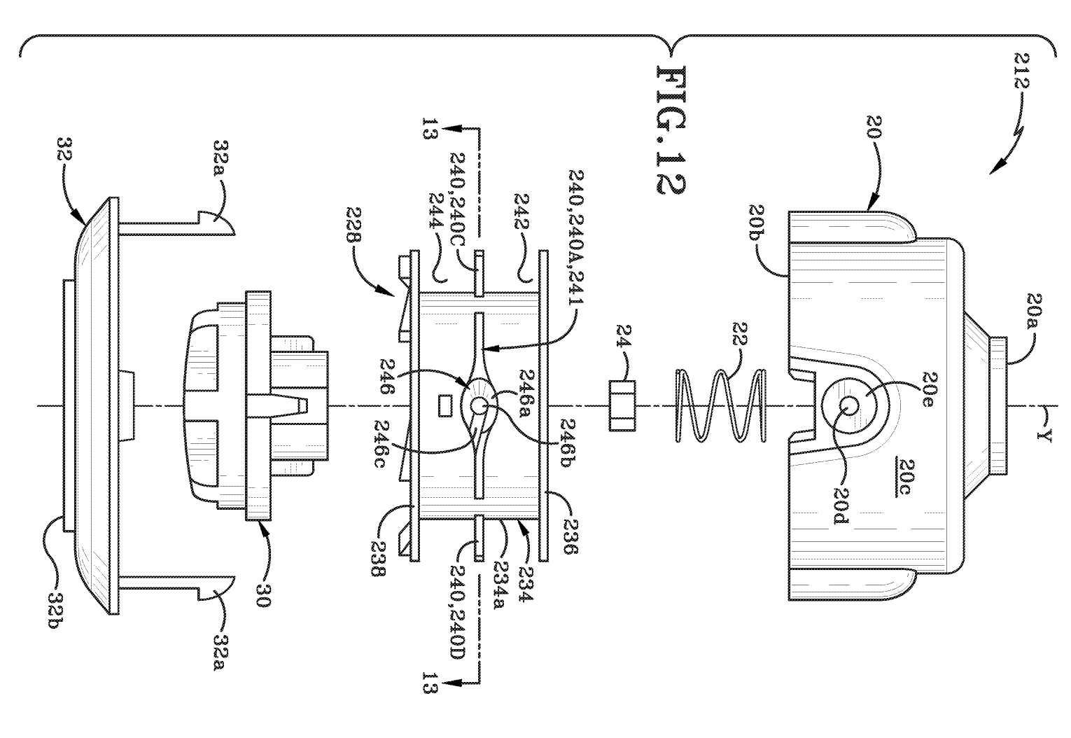

FIGS. 10A and 10B show a second embodiment of a spool, generally indicated at 128. Spool 128 may include a cylindrical hub 134 that has a first flange 136 at a top end and a second flange 138 at a bottom end. An exterior surface 134a of hub, first flange 136 and second flange 138 bound and define a single storage compartment 143. Hub 134 has an interior surface 134b that bounds and defines a bore 134c. A wall 134d extends across bore 134c or, alternatively one or more projections extend into bore 134c from interior surface 134b. A module 126 (shown in detail in FIGS. 11A, 11b) may be engaged with spool 128 such that module 126 sits on wall 134d or on projections extending into bore 134c. Module 126 may be therefore engaged with spool and provides a way for trimmer line (18) to be routed across the bore 134c of spool 128.

Flange 136, unlike flange 40, comprises an annular ring that extends radially outwardly from exterior surface 134a of wall 134. Flange 136, like flange 40 defines a funnel opening 146 that originate in the outer edge 137 and tapers inwardly towards hub 134. In other words, funnel opening 146 tapers in the same direction as trimmer line 18 will be inserted into funnel opening 146 and subsequently into guide channel 148. Funnel opening 146 may include a funnel region and a tubular region similar to funnel opening 46. Additionally, each funnel opening 146 may include a trimmer line guide 146c that directs trimmer line into the single storage compartment 143. Trimmer line guide 146c may be formed by a radially shorter wall section of the funnel opening 146 on one side of a plane of the flange 140. Module 126 may be inserted into spool and may be positioned such that a non-radial guide channel formed therein (discussed below) may be placed in communication with the two funnel openings 146.

Spool 128 may include a plurality of evenly spaced ramp projections 127 on an upper end 134e of hub 134 and also on a lower end of hub 134. Ramp projections 127 correspond with offset ramp projections located in the trimmer head housing (commonly known as a dog clutch). The engagement of ramp projections 127 and the ramp projections in the trimmer head may be for the purpose of indexing and limiting the amount of trimmer line 18 that may be dispensed from spool 128 each time the knob 30 may be tapped or bumped on the ground surface. Knob 130 may move vertically to dispense trimmer line 18 and can also rotate in a horizontal plane in one direction for loading or winding trimmer line 18 onto spool 128. Knob 130 may be illustrated as being selectively engageable with spool 128 but in other instances may be an independent part that will interlock with spool 128. In addition to projections 127 located on upper end 134e of hub 134 on an upper portion of knob 130 there may be a plurality of even spaced projections 127 and these engage with depressions and/or projections provided on a bottom portion of housing 120. These projections on the bottom portion of housing 120 may prevent spool 128 from rotating if knob 130 may be pressed inward against mechanical bias during operation of the trimmer head. Consequently, during operation, spool 128 may only release trimmer line 18 when spool 128 may be not resting on the top of bottom housing (where the bottom housing may be similar to bottom housing 32) or on the bottom of top housing 120. These positions limit how much trimmer line 18 may be released during operation by tapping or bumping knob 130 on the ground.

FIGS. 11A-11B show the second embodiment of a guide channel module in accordance with an aspect of the present disclosure, generally indicated at 126. Module 126 may be a disc-like member that may be receivable within the bore of the spool 28 in the same manner as module 26. Like module 26, module 126 does not include any central opening through which a region of driveshaft 14 might pass when guide channel module 126 may be received in bore 34c of spool 28.

Module 126 differs from module 26 in a number of ways which will be described hereafter. Module 126 has a first end 126a and an opposed second end 126b. A peripheral wall 126c originates in first end 126a and extends for a distance outwardly beyond second end 126b. Second end 126b may therefore be effectively recessed relative to wall 126c as can be seen in FIG. 11B. Unlike peripheral wall 26c, peripheral wall 126c of module 126 may define one slot 126d therein that may be similar to keyway 26h′. Peripheral wall 126c does not include any slots similar to slots 26h. The single slot 126d helps to ensure that module 126 may be able to be installed in the spool 28 in only one orientation. This helps to ensure that the guide channel 148 formed in module 126 will automatically be placed in the correct position to align with the openings 46 in the intermediate flange 40 of the spool 28 and thereby with eyelets 20d in upper housing 20. Wall 126c may also define two spaced-apart notches 126e similar to notches 26j.

Referring still to FIG. 10A-11B, module 126 differs from module 26 in that a recess 126f may be defined in first end 126a of module 126 and a generally annular wall 126g may bound and define this recess 126f. A portion of annular wall 126g may extend upwardly beyond first end 126a. Another portion of annular wall 126g may extend downwardly beyond second end 126b of module 126. Wall 126g may be generally concentric with peripheral wall 126c.

Module 126 may define a non-radial, angled guide channel 148 therein that may be similar to guide channel 48. Guide channel 148 may be comprised of two spaced-apart walls 148a, 148b that extend outwardly from second end 126b and extend from one region of peripheral wall 126c to another. Walls 148a, 148b extend through recess 126f. Walls 148a, 148b are laterally spaced apart and define a gap 148c between them. Module 126 further may include a top wall 148d that extends between the portions of the walls 148a, 148b that span recess 126f. (FIG. 11A). Walls 148a, 148b, wall 148d and a portion of the second end 126b bound and define guide channel 148. Guide channel 148 may have an entrance opening 148e in one of the notches 126d and an exit opening 148f in the other of the notches 126e. In other instances, the wall 148d may extend from notch 126d to notch 126e and define portions of the guide channel 148 that are located outside of the recess 126f.

Guide channel 148 may be similar to guide channel 48 in that it comprises a first section “S1” and a second section “S2”, each of which may be relatively straight along its length. The sections “S1” and “S2” intersect at an angle β relative to each other. When module 126 may be inserted into spool 28 in the same manner as has been described with respect to module 26, guide channel 148 may be placed in communication with the openings 46 defined in the intermediate flange 40 of the spool and thereby with eyelets 20d in the upper housing 20. The openings 46 and guide channel 148 together form a trimmer line conduit (not show) through which a length of trimmer line 18 may be inserted. When module 126 may be engaged in spool 28, the trimmer line conduit may comprise a funnel 46a that may lead into a tubular region 46b, that may lead into an opening 148e, that may lead into a straight section “S2”, that may into a straight section “S1” that may be oriented at an angle to straight section “S2”, that may lead into an opening 148f, that may lead into a tubular region 46b, that may lead into a funnel 46a. One or both of the first funnel 46a and second funnel 46a may be non-polygonal in cross-section. Guide channel 48 may be either polygonal or non-polygonal in cross-section.

As with module 26, when module 126 may be placed on wall 34e that extends across the bore 34d of spool 28, a portion of wall 34e forms a fourth wall that bounds and defined guide channel 148. Guide channel 148 may have a generally polygonal cross-section, being of a square or rectangular cross-section when module 126 is received within the spool 28 and viewed from either opening 148e or 148f. Additionally, a lower end of spring 22 will be seated around an exterior surface of annular wall 126g on first end 126a. Spring 22 thus urges module 126 into contact with wall 34e. Trimmer line 18 may be inserted through eyelets and through the trimmer line conduit in the same manner as through trimmer line conduit 50 and may be subsequently wound into the first and second storage compartments 42, 44 on spool 28 in the same way as with module 26 and spool 28.

FIG. 12 may be an exploded front elevation view of a second embodiment of the trimmer head that may be utilized on trimmer machine 10. The trimmer head shown in FIG. 12 may be represented by the reference number 212. Trimmer head 212 may be substantially identical to the trimmer head 12 shown in FIG. 2 except that there may be no module (like module 26) that may be engaged with the spool that aids in defining a guide channel in the trimmer head. Instead, the spool (which may be represented by the reference number 228) has a non-radial guide channel integrally formed therewith.

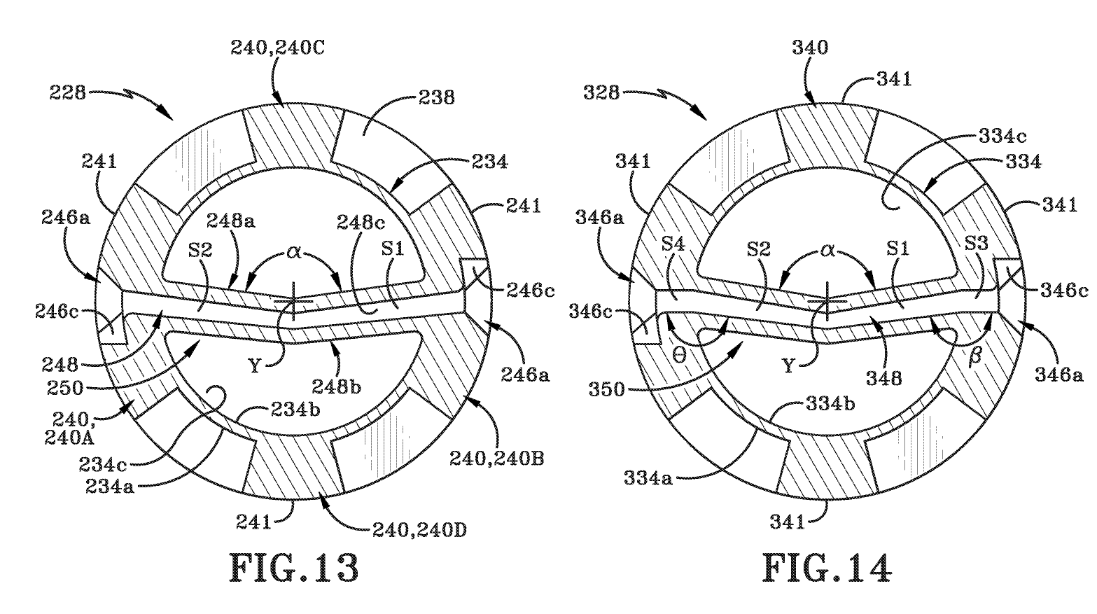

Spool 228 (FIG. 13) may be one exemplary spool that may be engaged in trimmer head 212. FIGS. 14-24B illustrate other differently configured spools that may be utilized in trimmer head 212 instead of spool 228. It should be understood that the integrally formed non-radial guide channels disclosed in FIGS. 12-24B may be formed in the first flange, the second flange or the intermediate flange of the spools.

FIG. 13 shows spool 228 that may be configured so that it does not include any central opening in an intermediate flange 240 thereof and through which part of driveshaft 14 might pass when spool 228 may be used in trimmer head 12.

Spool 228 may be substantially identical to spool 28 except for differences that exist in the intermediate flange and which will be described hereafter. Spool 228 may include a cylindrical hub 234 having an exterior surface 234a and an interior surface 234b (FIG. 14). Interior surface 234b may bound and define a bore 234c. Spool 228 further may include one or more flanges that extend radially outwardly from exterior surface 234a of hub 234. Spool 228, like spool 28, may include an upper flange (not shown) that may be identical to upper flange 36 and a lower flange 238 that may be identical to lower flange 38. Spool 228 further may include an intermediate flange 240 that differs from intermediate flange 40 in that guide channel 248 may be integrally formed with intermediate flange 240. Intermediate flange 240 may comprise a plurality of discrete, spaced apart sections that extend outwardly from the exterior surface 234a of hub 234. FIG. 13 shows four discrete arms of flange 240, with the arms being identified as first arm 240A, second arm 240B, third arm 240C and fourth arm 240D. (In other instances, flange 240 may comprise fewer than four arms or more than four arms. In yet other instances, flange 240 may comprise a continuous annular ring that extends outwardly from hub 234.)

FIG. 13 shows that spool 228 may be provided with a trimmer line conduit 250 that may be integrally formed with intermediate flange 240. Trimmer line conduit 250 may be comprised of a third embodiment of a guide channel 248 and two funnel openings 246. Guide channel 248 may be integrally formed with hub 234 and extends from one part of the interior surface 234b of hub 234 to another part of the interior surface 234b. At least a portion of guide channel 248 spans bore 234c. Guide channel 248 may be a non-radial guide channel. In other words, guide channel 248 does not pass through a center point “Y” of spool 228 but instead bypasses, goes around and may be offset from the center point “Y”. (Spool 228 may be rotatable about the axis “Y” that passes through the center point.)

Guide channel 248 may be defined by at least two spaced apart upstanding walls 248a, 248b, and a horizontal wall 248c. Walls 248a, 248b, 248c may be integrally formed with a region of intermediate flange 240 that spans bore 234c and with a region of intermediate flange 240 that extends radially outward from exterior surface 234a of hub 234. Walls 248a, 248b, 248c may, alternatively be integrally formed with hub 234. In either event, at least a portion of walls 248a, 248b, and 248c span bore 234c of hub 234. Walls 248a, 248b may be oriented at right angles to an upper surface of intermediate flange 240. In some instances, a region of the bore 234c may be located between wall 248a and the interior surface 234b of hub 234; and a second region of the bore 234c may be located between wall 248b and the interior surface 234b of hub 234. In other instances, a region of a horizontally oriented wall may be located between wall 248a and interior surface 234b; and between wall 248b and interior surface 24b. Although not illustrated herein, it should be understood that an upper wall and a lower wall 248c may extend between walls 248a and 248b so that an enclosed or partially enclosed guide channel 248 spans bore 234c. Guide channel 248 be polygonal in cross-section, being generally square or rectangular in cross-section. Guide channel 248 has a cross-sectional dimension that may be greater than an exterior diameter of trimmer line 18 that may be threaded through guide channel 248.

Guide channel 248 may extend beyond exterior surface 234a of hub 234 and may flare outwardly as it approaches the exterior perimeter 241 of flange 240. The portion of guide channel 248 that flares outwardly forms a funnel opening that may be identified by the reference number 246. Guide channel 248 may therefore include an entrance funnel 246a and an exit funnel 246b. As discussed earlier herein, the terms “entrance” and “exit” are terms simply used to more clearly describe the guide channel openings and should not be considered to limit which funnel into which an end of trimmer line 18 may be inserted and from which trimmer line 18 may exit. Entrance and exit funnels 246a, 246b may each also include a trimmer line guide 246c that extends circumferentially outwardly away from the portion of the funnel defined by the outer edge 241 of intermediate flange 240 trimmer line guide s 246c may be substantially identical in structure and function to trimmer line guide s 46.

Not only may guide channel 248 be non-radial but the guide channel 248 may be comprised of a first section “S1” and a second section “S2” that are oriented at an angle α relative to each other in a similar manner to sections “S1” and “S2” of module 126 and 26. Sections “S1” and “S2” extend from funnels 246a and 246b, respectively, to where the first and second sections “S1”, “S2” meet each other. Guide channel 248 may be of a substantially constant cross-sectional dimension for the entire length of each section “S1” and “S2”. In other instances, guide channel 248 may narrow proximate where sections “S1” and “S2” intersect. It should be noted that even at its narrowest point, guide channel 248 will still be of greater size than the exterior diameter of trimmer line 18 that may be threaded therethrough. Consequently, trimmer line 18 may be free to pass through guide channel 248 and therefore may be able to pass freely through trimmer line conduit 250. Trimmer line conduit 250 comprises a funnel 246a, that leads into a straight section “S1” that leads into a straight section “S2” oriented at an angle to “S1” that leads into a funnel 246a. It should be understood that spool 228 may be engaged within a cavity defined by upper housing 20 and bottom housing 32 and may be used in the same manner as spool 28 (with module 26 engaged) when engaged within a cavity defined by upper housing 20 and bottom housing 32.

FIG. 14 shows a spool 328 that does not include a module 26 or 126 but instead may include a trimmer line conduit 350 that may be integrally formed with one of the spool flanges, such as intermediate flange 340. It should be noted that spool 328 may be configured so that it does not include any central opening in intermediate flange 340 thereof and through which a region of driveshaft 14 might pass when spool 328 may be used in a trimmer head, such as trimmer head 12. Spool 328 may be configured to be engaged in trimmer head 12 and to function in a substantially identical way to spool 28 combined with module 26.

Trimmer line conduit 350 may be comprised of a fourth embodiment of a non-radial guide channel 348 and a pair of funnel openings 346. Spool 328 may be substantially identical to spool 228 and functions in a substantially identical manner. The difference between spool 328 and spool 228 may be that guide channel 348 may be comprised of four sections instead of two sections. Spool 328 therefore may include a first section “S1” and a second section “S2” that intersect each other but further may include a third section “S3” and a fourth section “S4”. First and second sections “S1”, “S2” intersect each other and are oriented at an angle α relative to each other. Third section “S3” and first section “S1” intersect each other and are oriented at an angle β relative to each other. Third section “S3” may be positioned between first section“S1” and funnel 346a. Fourth section “S4” and second section “S2” intersect each other and are oriented at an angle θ relative to each other. (θ and β may be of the same size or may be of different sizes.) Fourth section “S4” may be positioned between funnel 246b and second section “S2”. Furthermore, the straight sections “S3” and “S4” may be linearly aligned with each other.

It should be noted that the transition between first section “S1” and third section “S3” may occur at a location substantially aligned with hub 334, particularly with interior surface 334b of hub 334. Similarly, the transition between second section “S2” and fourth section “S4” may occur at a location substantially in alignment with hub 234, particular with interior surface 334b thereof. The transition of “S1” and “S3” may be located a distance circumferentially from the transition of “S2” and “S4”. It should be noted that first, second, third and fourth sections “S1” to “S4” may each be straight along their lengths.

Trimmer line conduit 350 comprises a funnel 346a, that leads into a straight section “S3” that leads into a straight section “S1” oriented at an angle to “S3” that leads into a straight section “S2” that may be oriented at an angle to “S1”, that leads into a straight section “S4” that may be oriented at an angle to “S2”, that leads into a funnel 346b. Trimmer line 18 may be inserted through trimmer line conduit 350 in a first direction starting at funnel 246a or in a second direction starting at funnel 246b. As with spool 228, spool 328 further may define storage compartment guide channels 346c formed in outer edge 341 and extending for a distance circumferentially and upwardly or downwardly from a region of funnels 346a and 346b. Storage compartment guide channels 346c are substantially identical in structure and function to storage compartment guide channels 246c. Spool 328 may be used in trimmer machine 10 in a substantially identical manner to spool 28 in combination with module 26.

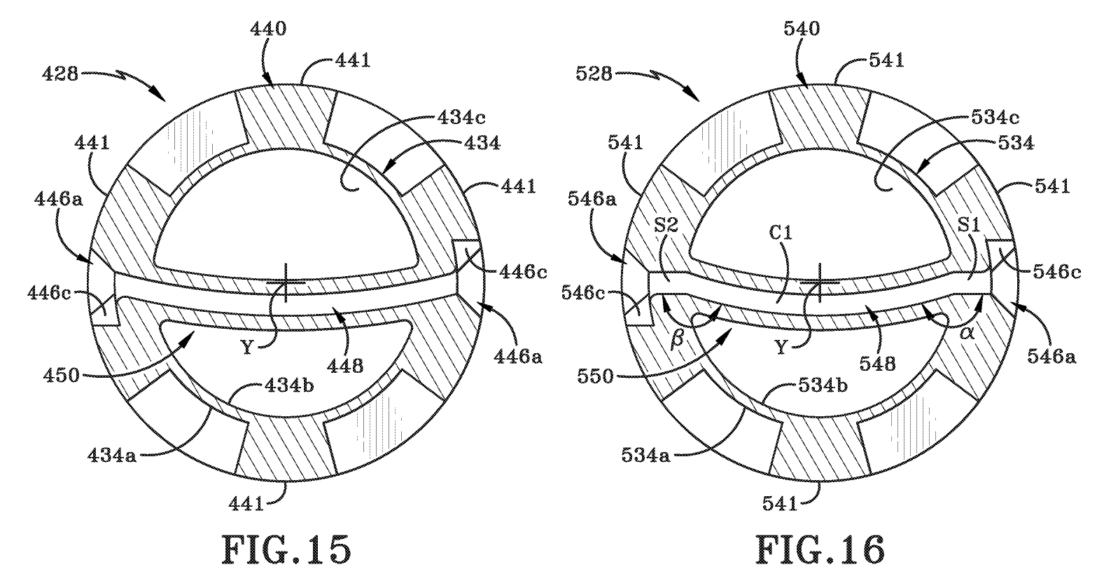

FIG. 15 shows a spool 428 in accordance with an aspect of the present disclosure. Spool 428, like spools 228 and 328 does not include any central opening for receiving a portion of a driveshaft 14 therethrough. Spool 428 may be substantially identical in structure and function to spool 228 except that instead of the spool being provided with a non-radial trimmer line conduit 250 having two intersecting substantially straight sections (“S1” and “S2”) with funnels 246a at either end; spool 428 may be provided with a fifth embodiment of a guide channel 448 therein. Guide channel 448 of trimmer line conduit 450 may be curved along its length. Trimmer line conduit 450 therefore comprises a curved, non-radial guide channel 448 that may be in communication with first and second funnels 446a. Funnels 446a may be defined in a section of intermediate flange 440 that extends radially outwardly from an exterior surface 434a of hub 434. The funnels 446a, 446b may be substantially identical in structure and function to funnels 246a, 246b and each funnel 446a, 446b may include a storage compartment guide channel 446c extending circumferentially outwardly therefrom and oriented upwardly or downwardly in order to guide trimmer line 18 into the first storage compartment or the second storage compartment of the spool 428 (where the first and second storage compartments are substantially identical to first and second storage compartments 42, 44).

At least a portion of guide channel 448 spans bore 434c of hub 434. Guide channel 448 does not pass through center point “Y” of spool 428 but instead bypasses, goes around and may be offset from the center point. Guide channel 448 may be therefore non-radial, i.e., does not extend along a radius of the circular wall of hub 434. Trimmer line conduit 450 that comprises a funnel 446a that leads into a curved guide channel 448 that leads into a funnel 446a. Spool 428 may be engaged in housing 26 and used in trimmer head 12 in a substantially identical manner to spool 28 in combination with module 26.

FIG. 16 shows a spool 528 that may be substantially identical in structure and function to spool 428 except that spool 528 may include a trimmer line conduit 550 that may include a sixth embodiment of a non-radial guide channel 548 therein. Spool 528 does not include a central opening that receives a driveshaft 14 of trimmer machine 10 therethrough. A portion of guide channel 548 may spans bore 534c of hub 534. Guide channel 548 may not pass through center point “Y” of hub 534 but instead may bypass, goes around and may be offset from the center point of spool 528. Guide channel 548 may therefore be non-radial, i.e., may not extend along a radius of the circular wall of hub 534.

Guide channel 548 differs from guide channel 448 in that guide channel 548 does not curve from funnel 546a to funnel 546a but instead may include a curved section “C1” that originates in one part of interior surface 534b of hub 534 and extends to another part of the interior surface 534b of hub 534. A straight tubular section “S1”, “S2” may be interposed between each funnel 546a and curved section “C1”. Trimmer line conduit 550 thus comprises a funnel 546a that leads to a straight section “S1” that leads to curved section “C1” oriented at an angle to straight section “S1”, that leads to a straight section “S2” that may be oriented at an angle to curved section “C1”, that leads to funnel 546a. First section “S1” may originate in alignment with interior surface 534b of hub 534 and may be oriented at an angle a relative to curved section “C1”. Second section “S2” may originate in alignment with interior surface 534b of hub 534 and may be oriented at an angle β relative to curved section “C1”. (The angles α and β may be the same or may be different.) Furthermore, the straight sections “S1” and “S2” may be linearly aligned with each other.

First and second funnels 546a may be formed in the part of intermediate flange 540 that extends radially outwardly from an exterior surface 534a of hub 534. The funnels 546a may be substantially identical in structure and function to funnels 246a and each funnel 546a may include a storage compartment guide channel 546c defined in outer edge 541 of intermediate flange 540. Storage compartment guide channels 546c are mirror images of each other and extend circumferentially outwardly from funnels 546a and are directed upwardly or downwardly, respectively, to guide trimmer line 18 into the first storage compartment or the second storage compartment of the spool 528. Spool 528 may be utilized in trimmer machine 10 in exactly the same manner as spool 28 in combination with module 26.

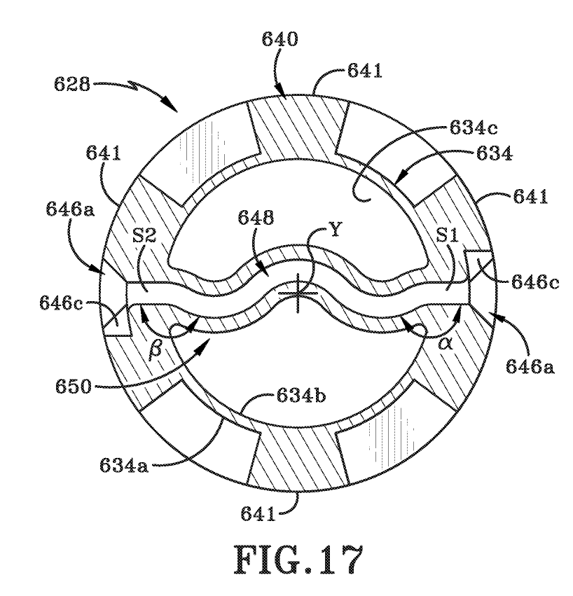

FIG. 17 shows a spool 628 in accordance with an aspect of the present disclosure. Spool 628 may be substantially identical to spool 528 except that spool 628 may include a seventh embodiment of a non-radial guide channel 648 that may be integrally formed therewith. Guide channel 648 differs from guide channel 548 in that the portion of the guide channel 648 that spans bore 634c of hub 634 does not have only a single radius of curvature like curved region “C1” but may instead be sinuous, i.e., may have multiple curves. None of these multiple curves may pass through the center point or center axis “Y” but instead may bypass, go around and be offset from the center point. The sinuous portion of the guide channel 648 may be therefor non-radial.

Trimmer line conduit 650 thus comprises a funnel 646a that leads into a straight section “S1” that leads into a sinuous guide channel 648 that may oriented at an angle to straight section “S1”, that leads into a second straight section “S2” that may be oriented at an angle to the connected portion of the sinuous guide channel 648, that leads into a funnel 646a. The straight sections “S1” and “S2” may be linearly aligned with each other. First section “S1” may originate in alignment with interior surface 634b of hub 634 and may be oriented at an angle a relative to a connected first region of the sinuous guide channel 648. Second section “S2” may originate in alignment with interior surface 634b of hub 634 and may be oriented at an angle β relative to a connected second region of the sinuous guide channel 648. (The angles α and β may be the same or may be different.) First and second funnels 646a, 646b may be formed in a section of intermediate flange 640 extending radially outwardly from an exterior surface 634a of hub 634. The funnels 646a, 646b are substantially identical in structure and function to funnels 246a, 246b and each funnel 646a, 646b may include a storage compartment guide channel 646c extending circumferentially outwardly therefrom and oriented to guide trimmer line 18 into the first storage compartment or the second storage compartment of the spool 628. Spool 628 may be engaged with trimmer head 12 and may be used in substantially the identical manner as spool 28 in conjunction with module 26.

FIG. 17 shows a cross-section of a trimmer head 712 that may include a spool 728 that may be engaged in a central cavity of housing 720. Trimmer head 712 and housing 720 are substantially identical in structure and function to trimmer head 12 and upper housing 20 except that spool 728 may be different from spool 28 and module 26 may be omitted. Spool 728 may be substantially identical in structure and function to spool 628, except that spool 728 may include a trimmer line conduit 750 that may include an eighth embodiment of a non-radial guide channel 748. Trimmer line conduit 750 comprises a funnel 746a that leads into a straight section “S1” that leads into a funnel 746a. Straight section “S1” bypasses and may be offset from center point “Y” (central axis “Y”) of spool 728. Guide channel 748 may extend between a first region of the interior surface 734b of hub 734 to a second region of the interior surface 734b of hub 734. First and second funnels 746a, 746b are defined in that portion of intermediate flange that extends radially outwardly from exterior surface 734a of hub 734. Funnels 746a, taper inwardly towards hub 734. Each funnel 746a may include a circumferentially extending trimmer line guide 746c similar in structure and function to trimmer line guide 46c. At least part of each of the first and second funnels 746a may be radially aligned with the central axis “Y”.

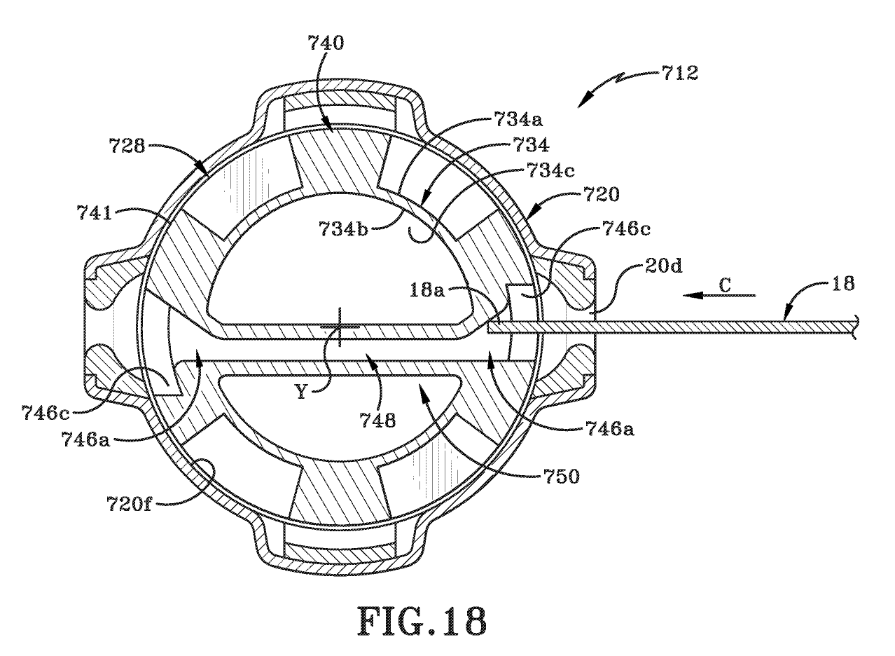

When spool 728 may be engaged with housing 720, an end 18a of a length of trimmer line 18 may be inserted through one of the eyelets 720d of housing 720 and into the adjacent one of the funnels 746a. End 18a may strike a portion of the wall of spool 728 that define funnel 746a and will be redirected into guide channel 748. Trimmer line 18 may be advanced through guide channel 748 in the direction indicated by arrow “C” (FIG. 18) until end 18a exits from funnel 746a. The user may then pull trimmer line 18 through trimmer line conduit 750 until equal lengths of trimmer line 18 extend outwardly from each end of the conduit. A knob substantially identical to knob 30 may then be actuated to rotate spool 728 about the central axis “Y” in order to wind the lengths of trimmer line 18 onto the exterior surface 734a of the hub 734 and into the first storage compartment and second storage compartment of spool 728. The first and second storage compartments may be substantially identical to first storage compartment 42 and second storage compartment 44 illustrated in FIG. 2.

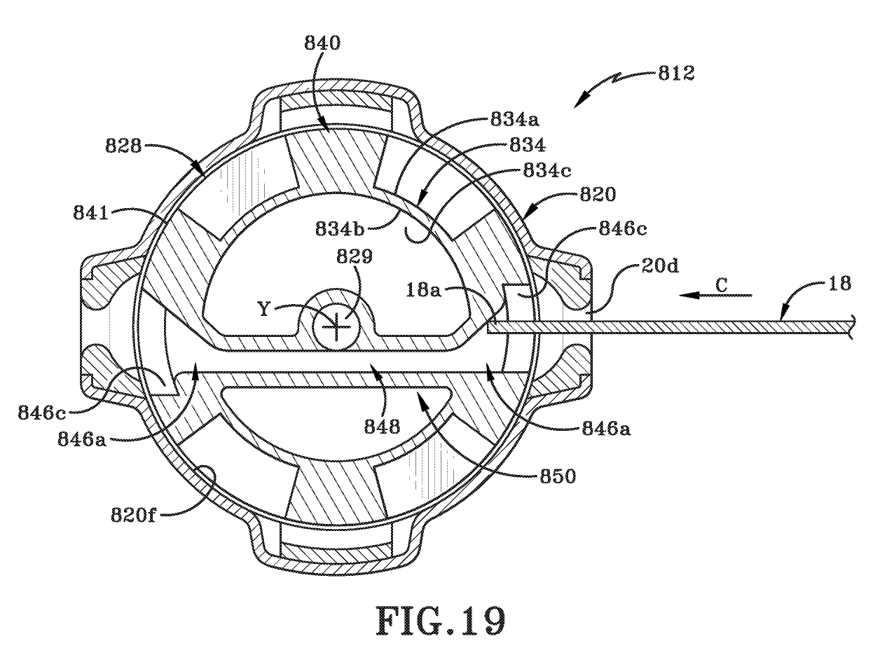

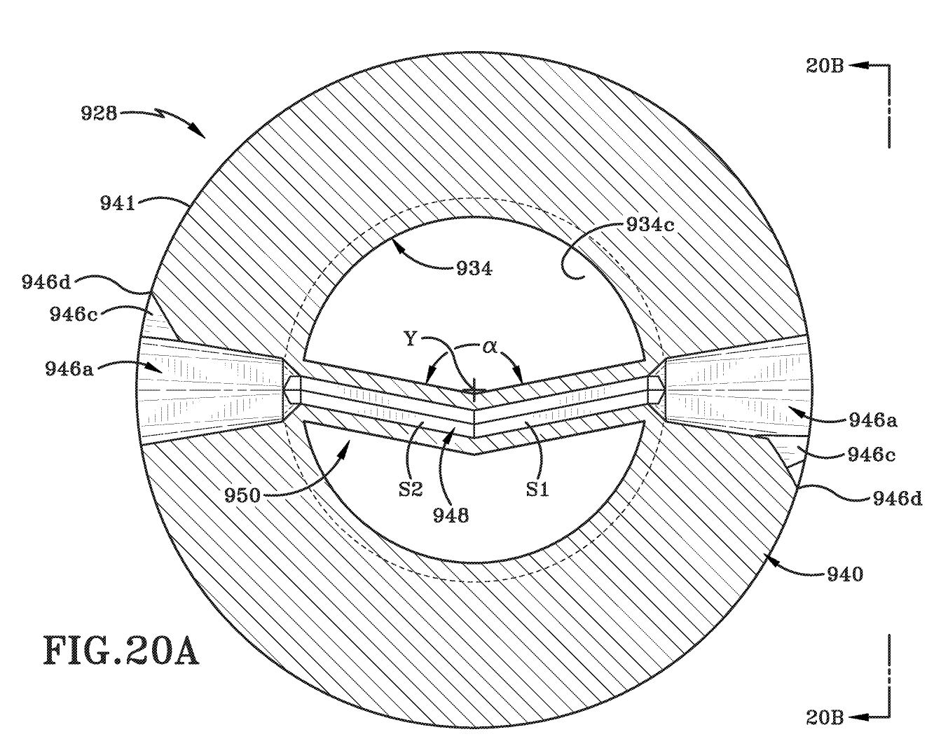

FIG. 19 shows a cross-section through a trimmer head 812 in accordance with the present disclosure. Trimmer head 812 may be substantially identical in structure and function to trimmer head 12 except that spool 828 may be different from spool 28 and module 26 may be not included. Spool 828 may be substantially identical in structure and function to spool 728 except that a ninth embodiment of a non-radial guide channel 848 may be integrally formed with intermediate flange 840 and flange 840 defines a central opening 829 therein while spool 728 may be free of any openings defined in the intermediate flange 740, particularly a central opening.

Spool 828 has an intermediate flange 840. At least a part of intermediate flange 840 extends radially outwardly from an exterior surface 834a of hub 834. Spool 828 may include a trimmer line conduit 850 comprising a straight, non-radial guide channel 848 that extends between a first funnel 846a and a second funnel 846a. Guide channel 848 may span bore 834c and extend between a first region of the interior surface 834b of hub 834 to a second region of the interior surface 834b of hub 834. Guide channel 848 bypasses and may be offset from central axis “Y”. Guide channel 848 may be defined by a pair of spaced-apart walls 848a and 848b. A central opening 829 may be defined in spool 828 adjacent wall 848b. Axis “Y” passes through central opening 829. The portion of guide channel 848 through which a length of trimmer line 18 may be threaded bypasses and may be laterally offset from central opening 829.

First and second funnels 846 originate proximate hub 834 and flare outwardly to an opening defined in outer edge 841 of intermediate flange 840. Funnels 846 taper in dimension inwardly towards hub 834. Each funnel 846a may include a circumferentially extending trimmer line guide 846c similar in structure and function to trimmer line guide 46c. Trimmer line conduit 850 therefore comprises a first funnel 846a that leads into a straight guide channel 848 that leads into a second funnel 846a.

When spool 828 may be engaged in trimmer head 812 an end 18a of a length of trimmer line 18 may be inserted through one of the eyelets 20d of upper housing 20 and into one of the funnels 846a. End 18a may strike a portion of the wall of spool 828 that defines funnel 846a and will be redirected into the non-radial guide channel 848. Trimmer line 18 may be advanced through guide channel 848 in the direction indicated by arrow “C” (FIG. 19) until end 18a exits from the other funnel 846a. The user may then pull trimmer line 18 through trimmer line conduit 850 until equal lengths of trimmer line 18 extend outwardly from each end of the trimmer line conduit 850. A knob identical to knob 30 (FIG. 2) may then be actuated to rotate spool 828 about the central axis “Y”. As spool 828 rotates, the lengths of trimmer line 18 wind onto exterior surface 834a of hub 834 and into the first storage compartment and second storage compartment of spool 828. The first and second storage compartments will be substantially identical to first storage compartment 42 and second storage compartment 44 illustrated in FIG. 2.

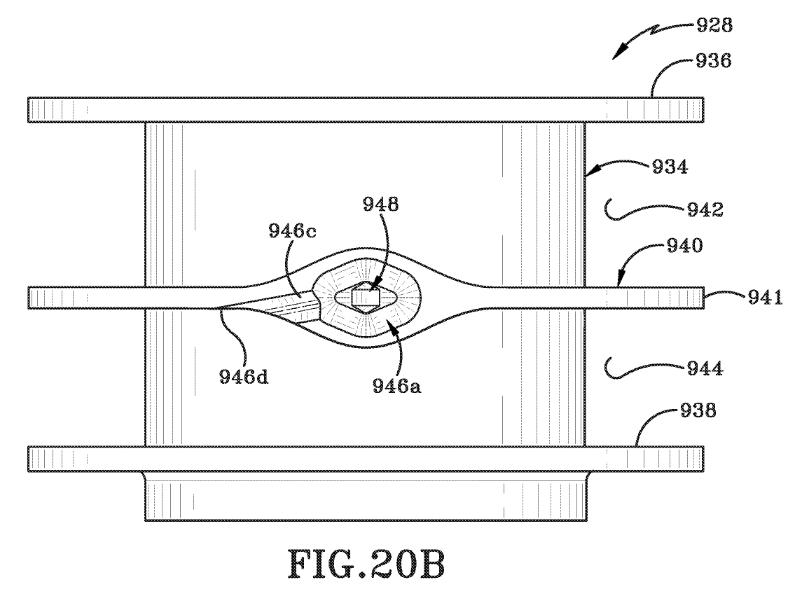

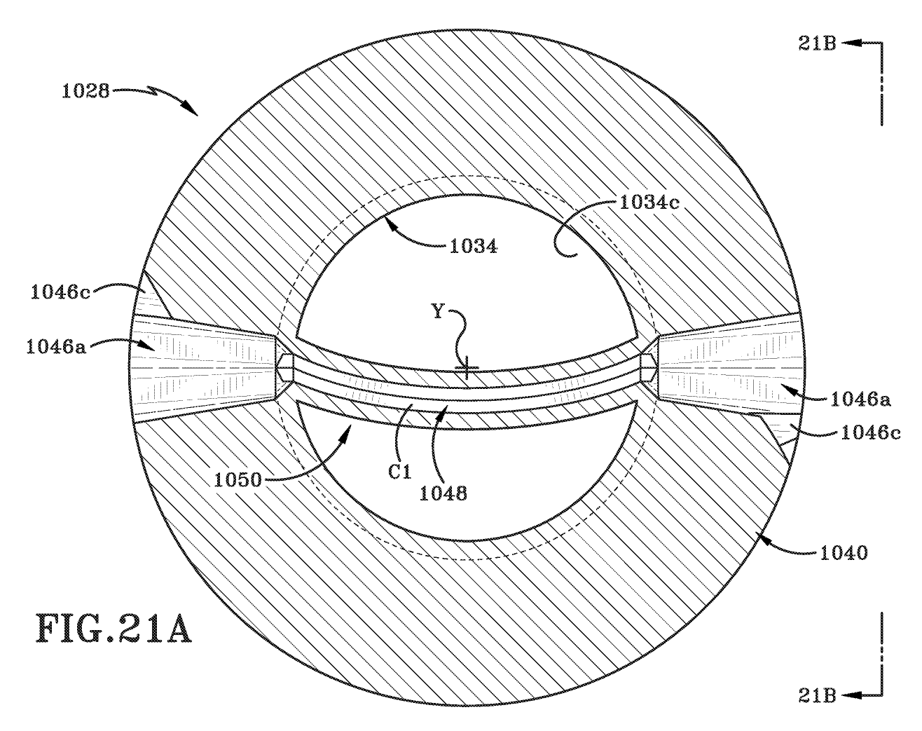

FIG. 20A shows a cross-section of a spool 928 that may be engaged in a central cavity 20f of upper housing 20 of trimmer head 12. Spool 928 may include a trimmer line conduit 950 that may include a tenth embodiment of a non-radial guide channel 940 integrally formed with intermediate flange 940. Trimmer line conduit 950 also may include a first flange 946a and a second flange 946a that extend outwardly in opposite directions from opposite ends of guide channel 940. Intermediate flange 940 may be illustrated herein as an annular ring instead of four discrete arms. It will be understood, however, that instead of annular ring, two or more arms may comprise intermediate flange 940.

Intermediate flange 940 may include a region that extends radially outwardly from an exterior surface 934a of hub 934. Spool 928 does not define a central opening therethrough. Funnels 946a extend from outer edge 941 of intermediate flange 940 to hub 934. Non-radial guide channel 948 extends from one region of hub 934 to a second region of hub 934 and therefore spans bore 934c. Guide channel 948 may include a first straight section “S1” and a second straight section “S2” First and second sections. “S1” and “S2” are oriented at an angle α relative to each other. Guide channel 948 may be different from guide channel 248 in the positions at which guide channel 948 transitions to funnels 946a relative to where guide channel 248 transitions to funnels 246a.

Furthermore, the shape of funnels 946a may be different from funnels 246a. Funnels 246a may be described as being generally V-shaped when the cross-section may be viewed from above as in FIG. 13 while funnel s 946a may be described as being generally U-shaped when the cross-section may be viewed from above as in FIG. 20A.

Additionally, as can be seen in FIG. 20B, guide channel 948 may be not square or rectangular in cross-sectional shape as may be guide channel 248. Guide channel 948 may be substantially hexagonal in cross-sectional shape. Consequently, instead of guide channel 948 being formed by a first wall 948a, a second wall 948b and a flat top wall and flat bottom wall (as may be the case with guide channel 248); guide channel 948, instead, has a substantially V-shaped top wall and a substantially V-shaped bottom wall.

Guide channel 948 also differs from guide channel 248 in that the trimmer line guide 946c may be V-shaped when viewed from the front or back (as in FIG. 20B). trimmer line guide 946c tapers from its greatest width where the trimmer line guide 946c originates in funnel 946a down towards apex 946d. Funnels 946 are mirror images of each other. The funnel 946 shown in FIG. 20B has a trimmer line guide 946c that angles downwardly to a second storage compartment 944 that may be defined between intermediate flange 940 and lower flange 938. The funnel 946 that may be located on an opposite side of spool 928 has a trimmer line guide 946c that angles upwardly toward a first storage compartment 942 defined between intermediate flange 940 and upper flange 936. It should be noted that the tapered V-shape of the trimmer line guide 946c extends for a distance circumferentially along outer edge 941 and an adjacent portion of the intermediate flange 940

Trimmer line conduit 950 comprises a funnel 946a that leads into a straight first section “S1” that may be angled relative to funnel 946a; first section “S1” leads into a straight second section “S2” that may be angled relative to first section “S1”, and second section “S2” leads into another funnel 946a and at an angle relative thereto. Spool 928 may be engaged with trimmer head 12 and used in substantially the same manner as any of the other spools described above.

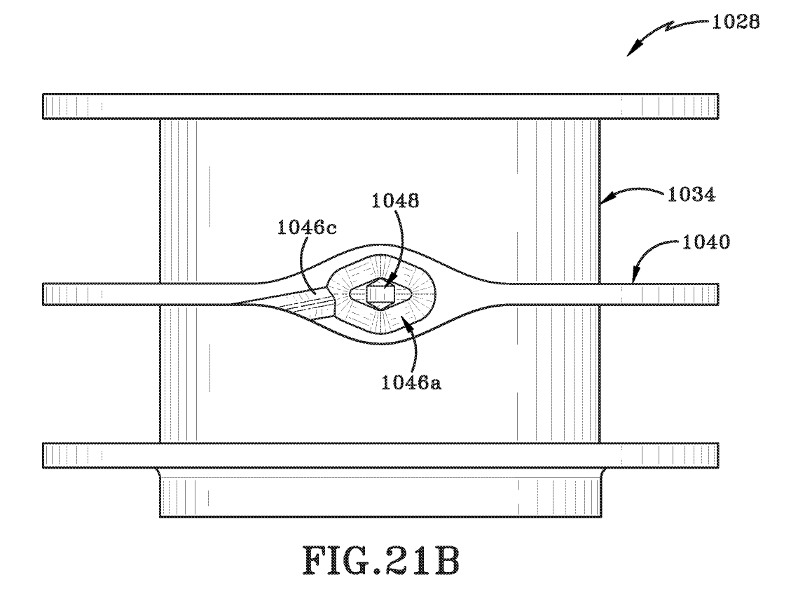

Referring to FIGS. 21A and 21B there may be shown a spool 1028 that may be substantially identical in structure and function to spool 928 except for the differences pointed out below. Spool 1028 may include a trimmer line conduit 1050 that may include two diametrically opposed funnels 1046a and an eleventh embodiment of a non-radial guide channel 1048. Funnels 1046a and their associated ports 1046c are substantially identical in structure and function to funnels 946a and ports 946c.

Guide channel 1048 spans bore 1034c defined by hub 1034 of spool 1028 and instead of being comprised of two straight sections that are angled relative to each other as may be the case with guide channel 948; guide channel 1048 curves between the two funnels 1046a. Guide channel 1048, like guide channel 948, may be substantially hexagonal in cross-section as can be seen in FIG. 21B. Guide channel 1048 therefore may be defined by two spaced apart side walls and a V-shaped upper wall and a V-shaped lower wall. Trimmer line conduit 1050 thus comprises a first funnel 1046a that leads into a curved section “C1” (i.e., guide channel 1048), that leads into a second funnel 1046a. Spool 1028 may be engaged in trimmer head 12 and used in a substantially identical manner to spool 28 in combination with module 26.

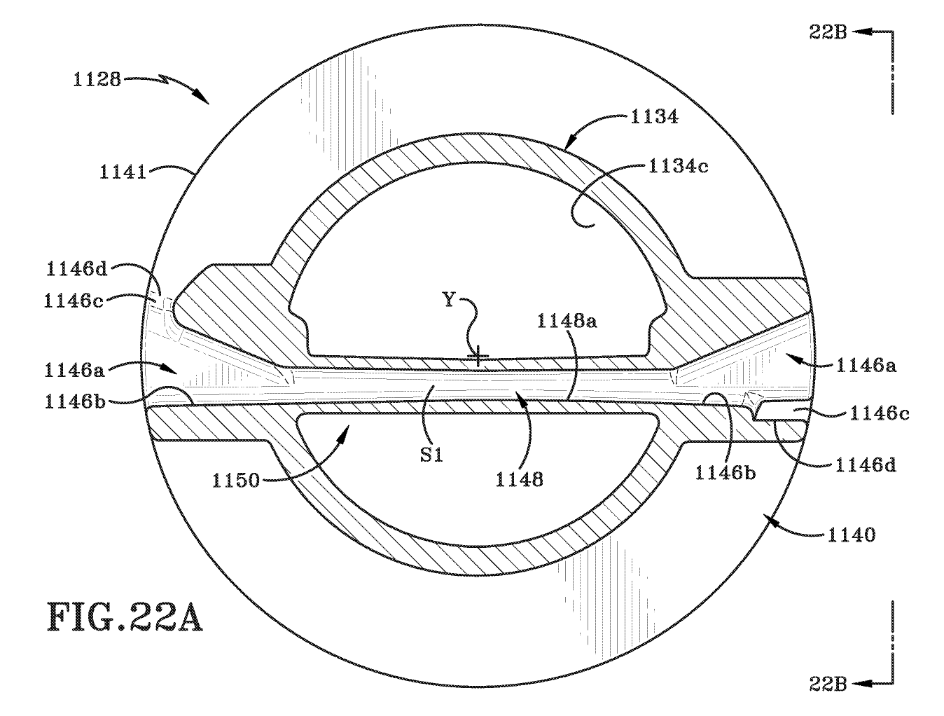

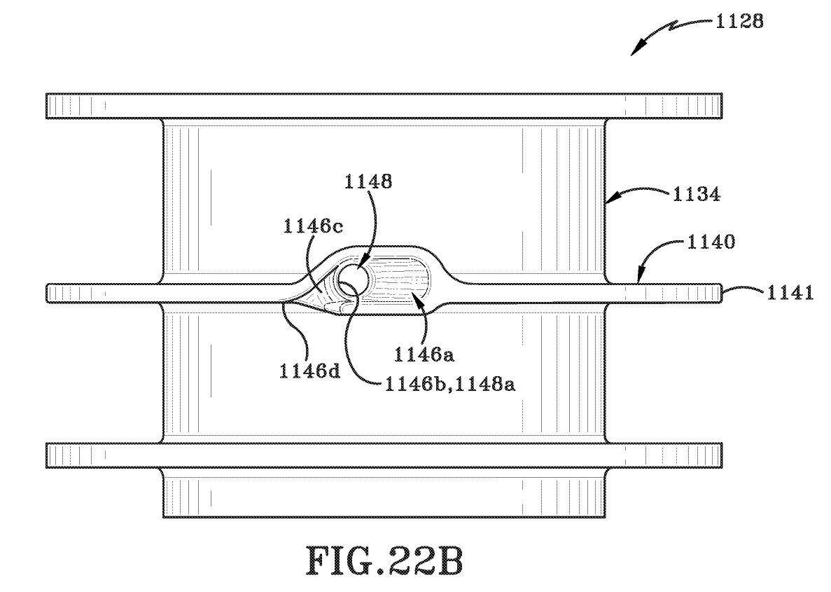

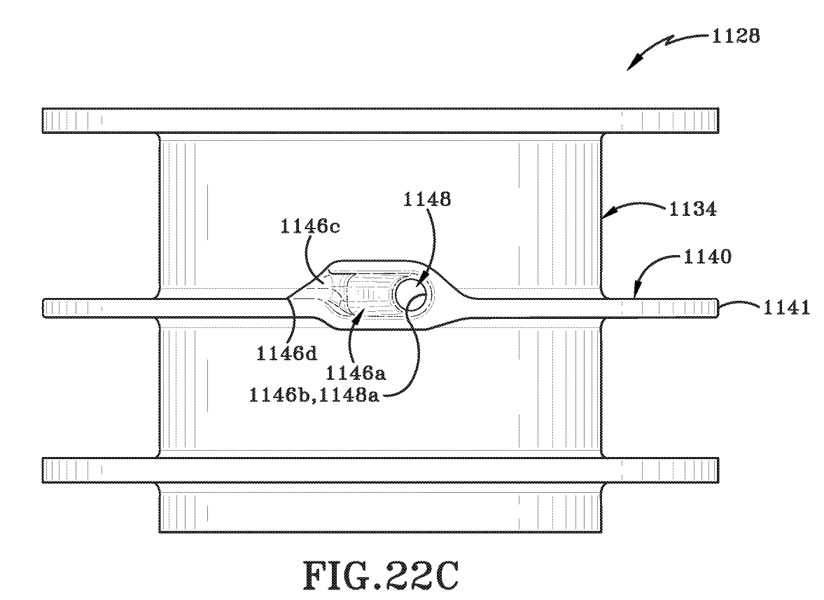

Referring to FIGS. 22A, 22B and 22C there may be shown a spool 1128 that may be substantially identical in structure and function to spool 928 except for the differences pointed out below. Spool 1128 may include a trimmer line conduit 1150 that may include two diametrically opposed funnels 1146a and a twelfth embodiment of a non-radial guide channel 1148. Funnels 1146a may be considered asymmetric funnels. The term “asymmetric” or “asymmetrical” may be used to describe a funnel that is not centered relative to location of the guide channel 1148. In other words, a section of the wall defining one region of the funnel on one side of the opening to the guide channel is shorter and more steeply tapered than a section of the wall defining a second region of the funnel on the other side of the opening to the guide channel which is longer and is more gently tapered. Funnels 1146a may each have one wall 1146b that may be substantially coplanar with one of the walls 1148a that defines guide channel 1148. The remaining portion of each funnel 1146a may angle outwardly away from the wall 1146b such that, when the cross-section is viewed from above, the funnel 1146a may be substantially V-shaped. Each funnel 1146a has a trimmer line guide 1146c defined in outer edge 1141 of intermediate flange 1140 and extending outwardly away from wall 1146b. Trimmer line guide 1146c may be substantially identical to trimmer line guide 946 and may have the tapering V-shape that terminates in apex 1146d remote from funnel 1146a. As is evident when comparing FIG. 22A and FIG. 22B, one of the trimmer line guides 1146c is shaped so as to direct trimmer line towards an upper chamber on the spool (i.e., between the top flange and intermediate flange), while the other trimmer line guide 1146c is shaped so as to direct trimmer line towards a lower chamber on the spool (i.e., between the intermediate flange and lower flange.)

Guide channel 1148 may be straight along its length and originates and terminates proximate hub 1134 of spool 1128, thus spanning bore 1134c. Guide channel 1148 may be non-radial and offset laterally from central point “Y” of intermediate flange 1140. Intermediate flange 1140 may be free of any central openings at central point “Y”. Guide channel 1148 differs from guide channel 948 in that guide channel 1148 may be generally circular in cross-section (FIG. 22B) while guide channel 948 may be substantially square or rectangular in shape.

Trimmer line conduit 1150 thus comprises a first funnel 1146a that leads into a straight section “S1” that leads into a second funnel 1146a. Spool 1128 may be engaged in trimmer head 12 and used in a substantially identical manner to spool 28 in combination with module 26.

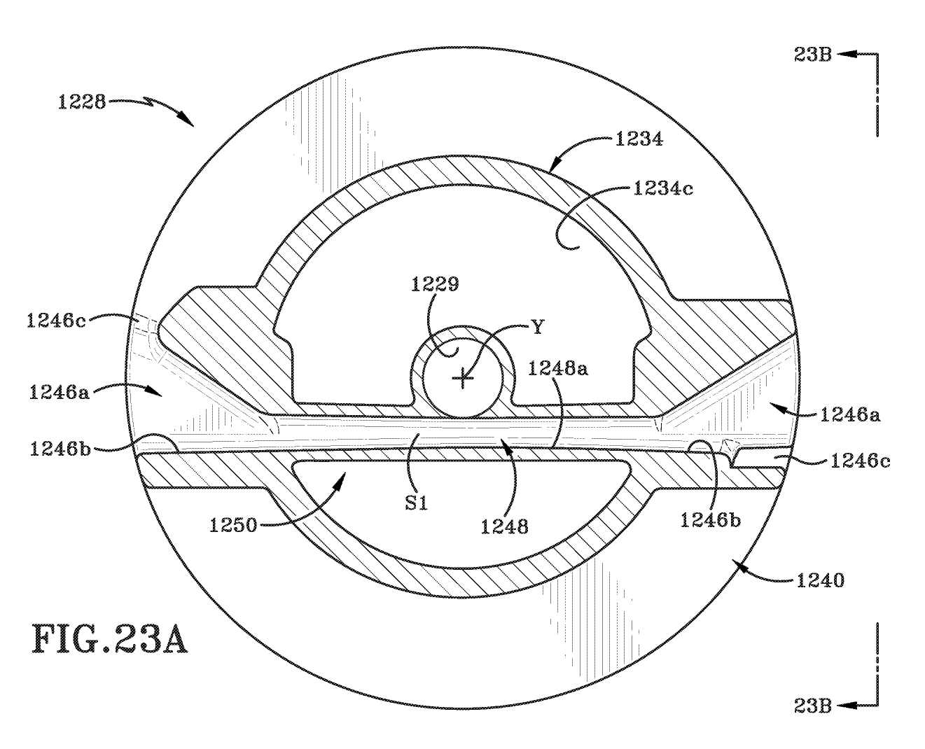

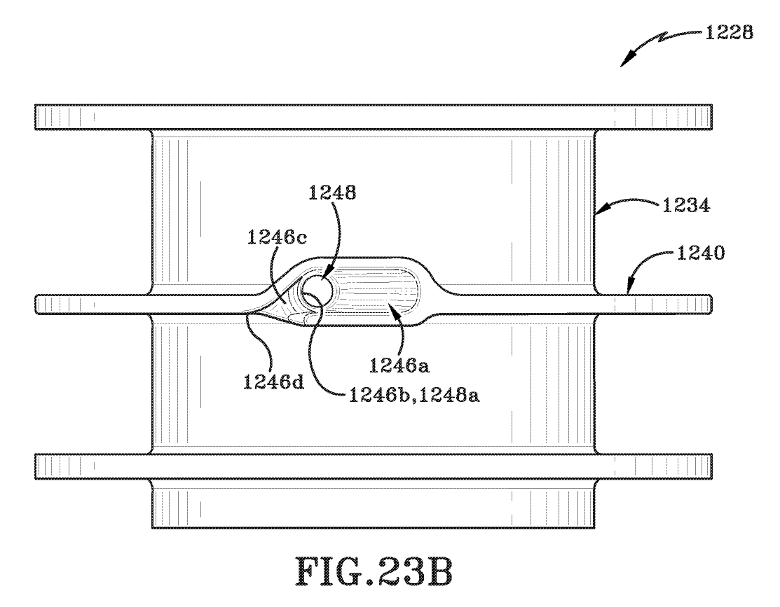

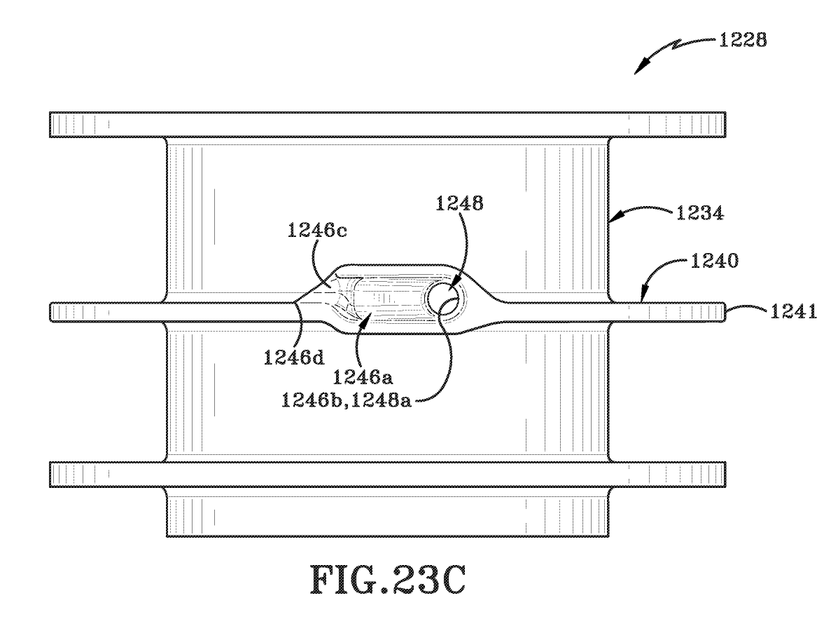

Referring to FIGS. 23A and 23B there may be shown a spool 1228 that may be substantially identical in structure and function to spool 1128 except for the differences pointed out below. Spool 1228 may include a trimmer line conduit 1250 that may include two diametrically opposed funnels 1246a and a thirteenth embodiment of a non-radial guide channel 1248. Funnels 1246a each have one wall 1246b that may be substantially coplanar with one of the walls 1248a that defines guide channel 1248. The remaining portion of each funnel 1246a may angle outwardly away from the wall 1246b such that, when the cross-section is viewed from above, the funnel 1246a may be substantially V-shaped. Each funnel 1246a has a trimmer line guide 1246c defined in outer edge 1241 of intermediate flange 1240 and extending outwardly away from wall 1246b. trimmer line guide 1246c may be substantially identical to trimmer line guide 1146c and has the tapering V-shape that terminates in apex 1246d remote from funnel 1246a.

Guide channel 1248 may be straight along its length and originates and terminates proximate hub 1234 of spool 1228. Guide channel 1248 may be non-radial and offset laterally from central point “Y” of intermediate flange 1140. Intermediate flange 1240 differs from intermediate flange 1140 in that there may be a central opening 1229 defined at central point “Y”. Guide channel 1248 is, however, laterally offset from central opening 1229. Guide channel 1248, like guide channel 1148, may be generally circular in cross-section (FIG. 23B).

Trimmer line conduit 1250 thus comprises a first funnel 1246a that leads into a straight section “S1” that leads into a second funnel 1246a. Spool 1228 may be engaged in trimmer head 12 and used in a substantially identical manner to spool 28 in combination with module 26.

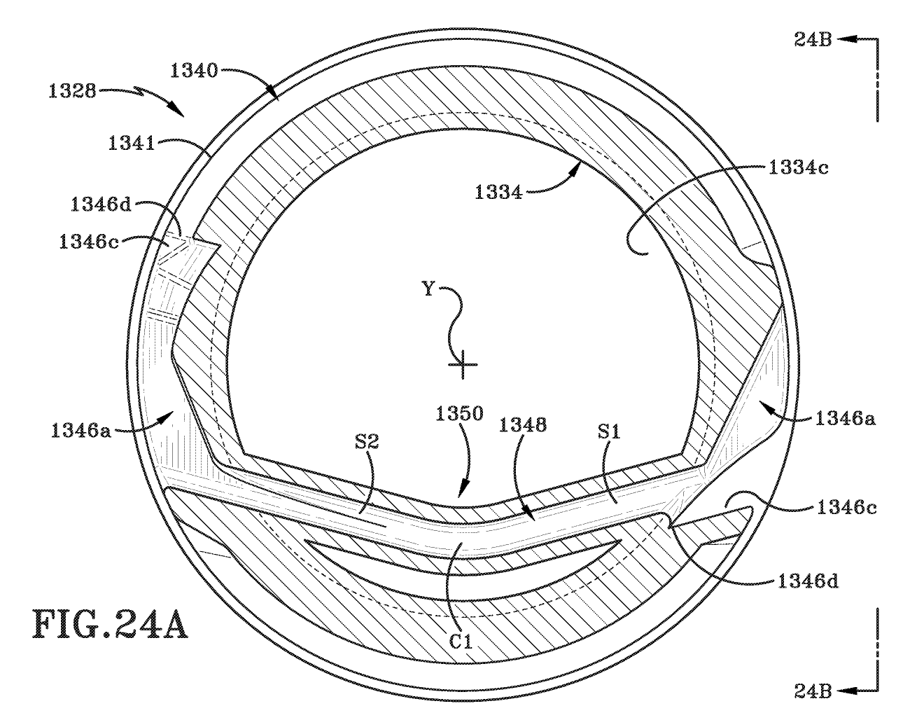

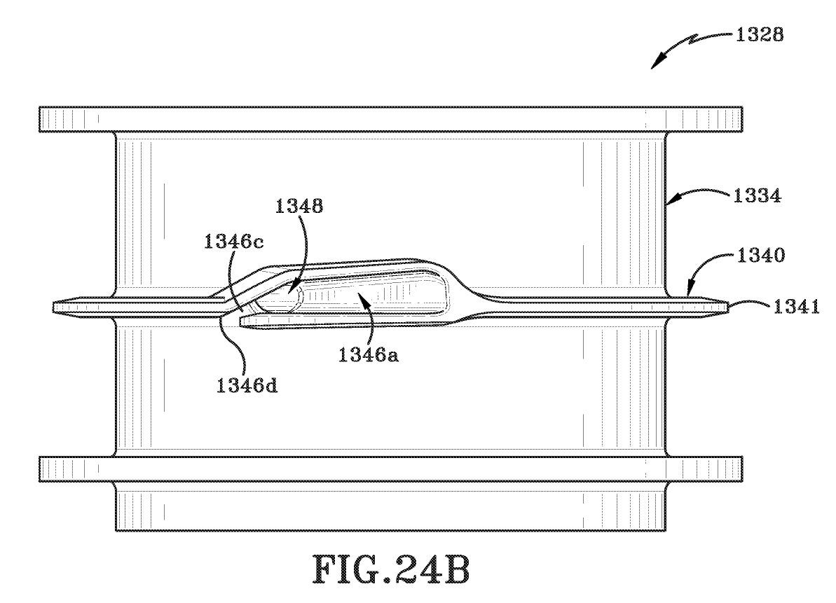

Referring to FIGS. 24A and 24B there may be shown a spool 1328 that may be similar in structure and function to spool 928 except for the differences pointed out below. Spool 1328 may include a trimmer line conduit 1350 that may include two opposed funnels 1346a and a fourteenth embodiment of a non-radial guide channel 1348. Funnels 1346a may be asymmetrical and substantially shallower and wider than are funnels 946. The term “shallower” indicates depth inwardly from outer edge 1341 towards hub 1334. The term “wider” indicates a length along outer edge 1341 of flange 1340. Each funnel 1346a has a trimmer line guide 1346c defined in outer edge 1341 of intermediate flange 1240 and extending inwardly towards hub 1334. Trimmer line guide 1346c may have a tapering V-shape that terminates in apex 1346d remote from funnel 1346a. The apex 1346d can be seen in FIG. 24A.

It should be noted that unlike spool 928, the funnels 1346a of spool 1328 are generally not positioned directly opposite each other on intermediate flange 1340. Instead, only a small part of the two funnels 1346a are oriented at 180 degree from each other and the remaining portions of the two funnels 1346a are oriented at less than 180 degrees from each other.

Guide channel 1348 originates and terminates proximate interior surface 1334c of hub 1334. Guide channel 1348 spans bore 1334c of spool 1328. Guide channel 1348 may be non-radial and offset laterally from central point “Y” of intermediate flange 1340. There may be no central opening defined at central point “Y”. Guide channel 1348 is, however, laterally offset from central point “y” to a greater degree than may be guide channel 948. Guide channel 1348 may also be generally circular in cross-section (FIG. 24B) as opposed to being of a hexagonal cross-section like guide channel 948.

Guide channel 1348 may include a first straight section “S1”, a second straight section “S2” and a curved section “C1” that may be positioned between first section “S1” and second section “S2”. Trimmer line conduit 1350 thus comprises a first funnel 1346a that leads into a straight section “S1” that leads into curved section

“C1” that leads into a second straight section “S2” that leads into a second funnel 1346a. Spool 1328 may be engaged in trimmer head 12 and used in a substantially identical manner to spool 28 in combination with module 26.

It will be understood while hub 34 has been shown in FIGS. 3-7 and described earlier herein as having detents 34d that are received in complementary slots 26h defined in guide channel module 26, the projections could, instead, extend outwardly from the peripheral wall 26c of guide channel module 26 and the complementary slots could be defined in the interior surface 34b of hub 34.

While openings 46 (i.e., funnels 46a) and guide channel 48 have been described herein as being located in intermediate flange 40, it should also be understood that in other instances it may be desirable to locate one or more openings 46 and the guide channel 48 in first flange 36 or in second flange 38 instead of in intermediate flange 40.

It will be understood that any of the non-radial channels illustrated herein as part of a module could instead be integrally formed on a spool. It will further be understood that any of the non-radial channels illustrated herein as an integral part of a spool could instead be provided on a module that may be then engaged with a complementary spool. It will further be understood that each of the different types of funnels illustrated herein may be utilized with any of the differently configured non-radial channels illustrated herein. Furthermore, the different non-radial channels (that are provided on the modules or integrally formed as part of a spool) could be provided on a spool that may be differently configured from the spool illustrated herein. Still further, the guide channels shown and described herein may be fabricated to have any of the illustrated cross-sectional shapes. So, for instance a guide channel that may be illustrated herein as being square in cross-section could instead be circular or hexagonal or any other desired cross-sectional shape.

Additionally, while a knob 30 may be illustrated and described herein as being the component that may be used to initiate rotation in spool 28 to wind a length of trimmer line 18 onto spool 28, it will be understood that mechanisms other than knob 30 could be used for this purpose.

Each module disclosed herein may have a key, tooth, spline, groove, or other device so that may be able to be properly aligned with the associated spool. The module may be reversible or rotatable to change the orientation, path or alignment of the module with the spool. The module may be preferably switchable with exterior modules to control the path through the spool so that the user may route the trimmer line in various paths. The module provide flexibility such as routing around a driveshaft, bolt or other similar device (if any) by providing a curved path or an angled path that does not pass through a center of the spool or bypasses or goes around a central opening (including going under the central opening); and provides a straight path that bypasses a central opening or may be offset therefrom. In other instances, such as is disclosed in U.S. Pat. No. 9,516,807 (Alliss) which is incorporated herein by reference, the module itself may be provided with a central opening that enables a driveshaft to pass therethrough. As such, the modules disclosed herein provide a mechanism for utilizing a particular spool in a long driveshaft trimmer machine or in a short driveshaft trimmer machine. The selective insertion of a module into a spool may therefore provide a mechanism for a user to convert a trimmer head that may be typically engaged with a trimmer machine that has a long driveshaft to one where the trimmer head may be used instead in a trimmer machine that has a short driveshaft, and vice versa.

It will be understood that while the spools shown in FIGS. 2 and 12 are illustrated as having ramps only on the lower flange 38; the spools could be fabricated to be symmetrical in appearance, i.e., having ramps on the upper flange 36 and on the lower flange 38. In this instance, the spool may be an invertible spool that can be used in a first orientation (lower flange down, for example) when the trimmer head may be engaged with a driveshaft that rotates in a first direction; and can be used in a second orientation (upper flange down, for example) when the trimmer head may be engaged with a driveshaft that rotates in a second, opposite direction.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the disclosure are an example and the disclosure may be not limited to the exact details shown or described.

1. A spool for a vegetation trimmer machine comprising:
a cylindrical hub including a first end and a second end and having an interior surface and an exterior surface extending between the first and second ends; wherein the interior surface defines a bore; wherein the hub has a central axis about which the hub is rotatable; and wherein the hub is free of a central opening for receiving a driveshaft therein;
at least one flange or a plurality of spokes extending radially outwardly from the exterior surface of the hub;
a first funnel defined in the at least one flange or the plurality of spokes;
a second funnel defined in the at least one flange or the plurality of spokes a distance circumferentially away from the first funnel; wherein the guide channel extends between the first funnel and the second funnels; and
a trimmer line conduit provided in the spool, said trimmer line conduit including a guide channel that is non-radial and bypasses the central axis; and wherein said guide channel spans the bore of the hub.

2. The spool as defined in claim 1, further comprising a module that is received in the bore of the spool; wherein the guide channel is defined at least partially in the module; and wherein the guide channel is placed in communication with the first funnel and the second funnel when the module is received in the bore of the hub.

3. The spool as defined in claim 2, wherein the module has an upper surface that is substantially continuous and is free of a central opening through which a driveshaft of a vegetation trimmer machine is receivable.

4. The spool defined in claim 1, wherein the trimmer line conduit is integrally formed in the spool.

5. The spool as defined in claim 1, wherein the first funnel and the second funnel each includes a first opening defined in an outer edge of the at least one flange or the plurality of spokes; and wherein the first funnel and the second funnel each taper inwardly from the first opening towards the hub.

6. The spool as defined in claim 1, wherein the guide channel is straight or is curved or is sinuous.

7. The spool as defined in claim 1, wherein one or both of the first funnel and the second funnel is non-polygonal in cross-section.

8. The spool as defined in claim 1, wherein the guide channel is polygonal in cross-section.

9. The spool as defined in claim 1, wherein the guide channel is non-polygonal in cross-section.

10. The spool as defined in claim 1, further comprising a trimmer line guide in communication with the first funnel or with the second funnel wherein the trimmer line guide tapers inwardly from an outer edge of the at least one flange or the plurality of spokes to an apex located proximate the hub; wherein the trimmer line guide is adapted to direct trimmer line towards the hub.

11. The spool as defined in claim 1, wherein the at least one flange or the plurality of spokes comprises a first arm and a second arm that extend radially outwardly from the exterior surface of the hub; and wherein the first funnel is defined in the first arm and the second funnel is defined in the second arm.

12. A method of engaging trimmer line in a spool of a trimmer machine comprising steps of:
providing a spool that has a cylindrical hub, wherein the spool is rotatable about a central axis of the hub and is free of a central opening for receiving a driveshaft of the trimmer machine therein;
providing a non-radial guide channel in the spool that at least partially spans a bore defined by the hub, wherein the guide channel does not pass through the central axis;
providing two funnels in the spool that lead into the guide channel;
providing a housing that receives said spool therein, wherein eyelets are formed in the housing;
aligning said eyelets with said funnels that lead to the guide channel;
providing a length of trimmer line;
inserting a first end of the trimmer line into a first one of the eyelets;
advancing the trimmer line into a first one of the two funnels, through the guide channel, through a second one of the two funnels; and out of a second one of the eyelets; and
rotating the spool relative to the housing to wind trimmer line onto an exterior surface of the hub of the spool.

13. The method as defined in claim 12, wherein the step of providing the non-radial guide channel in the spool comprises:
inserting a removable and replaceable module into a bore defined by an interior surface of the hub; wherein the module is free of a central opening for receiving the driveshaft of the trimmer machine therein; and
forming at least a part of the non-radial guide channel in the module.

14. The method as defined in claim 12, further comprising:
providing at least one flange or a plurality of spokes extending radially outwardly from an exterior surface of the hub;
defining a first funnel of the two funnels in a first region of the at least one flange or the plurality of spokes;
defining a second funnel of the two funnels in a second region of the least one flange; and
placing the first funnel and the second funnel in communication with the guide channel.

15. The method as defined in claim 12, wherein the step of providing the non-radial guide channel comprises integrally forming the non-radial guide channel in the spool.

16. A method of loading trimmer line into a vegetation trimmer head; said method comprising:
providing a spool having a hub with at least one flange or a plurality of spokes extending radially outwardly from an exterior surface of the hub; wherein an interior surface of the hub defines a bore; wherein the spool further defines a central opening adapted to receive a long driveshaft of a vegetation trimmer machine therethrough; and wherein the spool is rotatable about a central axis;
providing a first module that at least partially defines a non-radial guide channel therein; wherein the first module is free of a central opening for receiving the long driveshaft therein;
inserting the first module into the bore of the spool; bypassing the central axis with the non-radial guide channel;
placing the non-radial guide channel in fluid communication with a first funnel defined in a first region of the at least one flange or the plurality of spokes and with a second funnel defined in a second region of the least one flange;
forming a trimmer line conduit through the spool with the first funnel leading into the non-radial guide channel, leading into the second funnel;
enclosing the spool in a cavity of a trimmer housing;
engaging the trimmer head with a short driveshaft of a trimmer machine;
aligning the trimmer line conduit with eyelets provided on the trimmer housing;
advancing a length of trimmer line through a first one of the eyelets, through the trimmer line conduit; and through a second one of the eyelets;
rotating the spool about the central axis; and
winding the length of trimmer line onto the exterior surface of the hub.

17. The method as defined in claim 16, wherein the step of defining the non-radial guide channel in the first module further comprises:
forming in the first module a straight non-radial guide channel or a curved non-radial guide channel or a sinuous non-radial guide channel or a non-radial guide channel with two or more straight sections that intersect at an angle.

18. The method as defined in claim 16, further comprising:
forming a keyway in one of the first module and the interior surface of the hub; and forming a keyseat in the other of the first module and the interior surface of the hub; and
engaging the keyway in the keyseat when the first module is inserted into the bore.

19. A method of utilizing a same trimmer head spool in different vegetation trimmer machines, said method comprising:
providing a trimmer head spool including a cylindrical hub with a first end and a second end; wherein an interior surface of the hub defines a bore; and wherein the spool has at least one flange or a plurality of spokes extending radially outwardly from an exterior surface of the hub;
defining a trimmer line conduit through the spool, wherein the trimmer line conduit comprises a first flange and a second flange that are at least partially defined in the at least one flange or the plurality of spokes; wherein the trimmer line conduit includes a non-radial guide channel that extends between the first flange and the second flange and spans the bore; wherein the guide channel is offset from or goes around a central axis about which the spool is rotatable;
engaging the spool in a trimmer head housing;
selecting a first vegetation trimmer machine that includes a long driveshaft or a second vegetation trimmer machine that includes a short driveshaft;
engaging the trimmer head housing with the selected one of the first vegetation trimmer machine or the second vegetation trimmer machine;
aligning eyelets provided in the trimmer head housing with the trimmer line conduit;
advancing a length of trimmer line through a first one of the eyelets, through the trimmer line conduit and through a second one of the eyelets;
rotating the spool about the central axis; and
winding at least part of the length of trimmer line onto the exterior surface of the hub.

20. The method as defined in claim 19, wherein the step of defining the trimmer line conduit includes
inserting a first module into the bore of the hub; wherein the first module at least partially defines the non-radial guide channel therein; wherein a top surface of the first module is substantially continuous and is free of a central opening for receiving a driveshaft therein; and wherein
the step of selecting comprises selecting the second vegetation trimmer machine.

21. The method as defined in claim 19, wherein the step of defining the trimmer line conduit includes
inserting a first module into the bore of the hub; wherein the first module at least partially defines the non-radial guide channel therein; and wherein the first module defines a central opening that extends from a top surface of the first module to a bottom surface thereof; and wherein the non-radial guide channel bypasses the central opening;
wherein the step of selecting comprises selecting the first vegetation trimmer machine; and
wherein the step of engaging the trimmer head housing includes inserting an end of the long driveshaft through the central opening of the first module and operatively engaging the end of the long driveshaft with the spool.

22. The method as defined in claim 19, wherein the step of defining the trimmer line conduit comprises at least partially integrally forming the trimmer line conduit in a wall of the spool that extends across the bore, wherein the wall is free of a central opening for receiving the long driveshaft therethrough; and wherein the step of engaging comprises engaging the trimmer head housing with the second vegetation trimmer machine with the short driveshaft.

23. The method as defined in claim 22, wherein the step of defining the trimmer line conduit in the wall includes providing the wall with a central opening and bypassing the central opening with the guide channel; wherein the step of engaging comprises engaging the trimmer head housing with the first vegetation trimmer machine; and
inserting the long driveshaft through the central opening in the wall.
